(19) United States
(12) Patent Application Publication
(10) Pub. No.: US 2013/0089769 A1
(43) Pub. Date: Apr. 11, 2013

(54) THIN FLEXIBLE ELECTROCHEMICAL ENERGY CELL

(71) Applicants: Robert Benjamin Proctor, McLean, VA (US); Martin C. Peckerar, Silver Spring, MD (US); Zeynep Dilli, Hyattsville, MD (US); Mahsa Dornajafi, Adelphi, MD (US); Daniel Lowy, Woodbridge, VA (US)

(72) Inventors: Robert Benjamin Proctor, McLean, VA (US); Martin C. Peckerar, Silver Spring, MD (US); Zeynep Dilli, Hyattsville, MD (US); Mahsa Dornajafi, Adelphi, MD (US); Daniel Lowy, Woodbridge, VA (US)

(73) Assignee: FlexEL, LLC, College Park, MD (US)

(21) Appl. No.: 13/642,236

(22) PCT Filed: Apr. 28, 2011
(86) PCT No.: PCT/US2011/034314

§ 371 Date: Dec. 19, 2012

Related U.S. Application Data
(60) Provisional application No. 61/328,751, filed on Apr. 28, 2010.

(51) Int. Cl. H01M 4/48; H01M 12/00

(52) U.S. Cl. CPC H01M 4/48; H01M 12/00; B82Y 30/00
USPC 429/127; 429/218.1; 429/211; 429/301; 429/231.8; 429/215; 429/229; 429/225; 29/623.5; 977/742; 977/748

(57) ABSTRACT

An electrochemical energy cell has a galvanic cell including an anode electrode unit, a cathode electrode unit, an electrolyte body between the anode and cathode electrode units and contacting both the anode and cathode electrode units, and a separator layer including the electrolyte body and placed within the cell to contact both the anode and cathode electrode units to bring the anode and cathode electrode units in contact with the electrolyte body. The cathode electrode unit includes a cathode material including a powder mixture of a powder of hydrated ruthenium oxide and one or more additives. The anode electrode unit includes a structure formed of an oxidizable metal, and the separator layer includes a material that is porous to ions in liquid and is electrically non-conductive. A flexible electrochemical cell can be configured for a reduction-oxidation reaction to generate power at a surface of the electrode unit(s).

### CROSS-REFERENCE TO RELATED APPLICATION

This application claims the benefit of priority to U.S. Provisional Patent Application No. 61/328,751, entitled “Thin Flexible Rechargeable Electrochemical Energy Cell with Enhanced Capacity,” filed on Apr. 28, 2010, the disclosure of which is incorporated by reference.

### TECHNICAL FIELD

This disclosure is generally directed to electrochemical energy cells.

### BACKGROUND

The operation of a battery can be based on electrochemical reactions in which electrons are produced. The electrons can flow from the negative terminal of the battery to the positive terminal through a load connected between the positive and negative terminals, forming an electrical current produced by the battery.

### SUMMARY

Aspects of this disclosure relate to an electrochemical energy cell that includes at least one galvanic cell including: an anode electrode unit; a cathode electrode unit; an electrolyte body between the anode and cathode electrode units and contacting both the anode and cathode electrode units; and a separator layer including the electrolyte body and placed within the cell to contact both the anode and cathode electrode units to bring the anode and cathode electrode units in contact with the electrolyte body. The cathode electrode unit includes a cathode material comprising a powder mixture of a powder of hydrated ruthenium oxide and one or more additives. The anode electrode unit includes a structure formed of an oxidizable metal. The separator layer includes a material that is porous to ions in liquid and is electrically non-conductive.

One or more optional features may be included or involved with the electrochemical energy cell. The separator layer can include a permeable, electrically insulating separator layer saturated with the electrolyte body. The one or more additives can include activated carbon. The cathode material can be configured to enable the cell to have one or more properties including a first property of having an increased level of conductivity in the cell, a second property to increase a level of a rate of chemical and electrochemical reactions related to an operation of a battery, or a third property to suppress one or more reactions that are harmful to the battery. The electrochemical energy cell can include a cathode current collector structure, where the cathode material is suspended in the electrolyte body and spread over the cathode current collector structure. The cathode electrode unit can include a coating of the cathode material on an electrically conductive, chemically inert material that serves as a cathode current collector. The coating of the cathode material can be a product of at least one of a Langmuir-Blodgett-based coating, a screen printing, an inkjet printing, an aerosol-based printing, a gravure coating, a reverse gravure coating, and a deposition. The structure of the anode electrode unit can be formed of the oxidizable metal and additives to contribute to one or more properties of the cell, the one or more properties can include: a property related to increasing a level of a conductivity in the cell, a property related to increasing a rate of a chemical reaction or an electrochemical reaction related to a battery performance, a property related to desecrating a rate of reactions in the cell that are detrimental to a battery performance. An entirety of the anode electrode unit can be formed as an anode current collector from a form of the oxidizable metal. The cell can have electrical contact, where the electrical contact can have the oxidizable metal or another conductive material. A part of the anode electrode unit can be formed as an anode current collector, where in some cases, only a part of the entirety of the anode electrode unit can be formed as an anode current collector. The anode current collector can be covered, coated or in contact with a form of the oxidizable metal or another conductive metal as an electrical contact. The electrolyte body can include a solvent and solutes that affect chemical and electrochemical reactions related to a battery. The electrochemical energy cell can be configured to operate as a battery. The cathode material can have an effective surface area over which a battery operation occurs, where the effective surface area of the cathode material affects a level of a performance of the battery, and where the effective surface area can be larger than a footprint of the cell. The electrochemical energy cell can be configured to operate as a battery, where the battery can be a folded design structure and/or has the cathode electrode unit or the anode electrode unit substantially positioned within a pocket structure of the battery. The electrochemical energy cell can be configured to operate as a battery, where the cathode material can have an effective surface area that affects a level of a performance of the battery, and a size of the effective surface area can be determined as a function of at least one of the following: material properties of the cathode material, a porosity of hydrated ruthenium oxide particles, a porosity of activated carbon particles, sizes of the hydrated ruthenium oxide and activated carbon particles, or a mixing method involving placing the cell in a sonic bath. The cathode electrode unit can include a cathode current collector and a paste of the cathode material spread on the cathode current collector. The cathode electrode unit can also include additives suspended in an electrolyte spread on the cathode current collector. The cathode electrode unit can include a cathode current collector comprising a mesh with holes, where the cathode electrode unit can include additives pressed through the mesh of the cathode current collector. The cathode electrode unit can include a cathode current collector coated by the cathode material. The cathode electrode unit can include a cathode current collector, where the cathode current collector can include a material that is electrically conductive and chemically inactive in regards to a battery operation. The material for the cathode current collector can include at least one of graphite or carbon cloth. The additives can include one or more of agar, sucrose, sorbitol, platinum, palladium, iridium oxide, indium oxide, magnetite, Nafion™, metal-functionalized carbon nanotubes, nickel-plated carbon nanotubes, titanium dioxide, tungsten carbide, sodium chloride, and polyethylene glycols. The cathode material can include another material configured to receive electrons from a circuit and ions from the electrolyte body, and configured to facilitate a plurality of oxidation states. The structure for the anode electrode unit can be in a form of a layer, a sheet, a foil or a mesh. The oxidizable metal can be at least one of zinc, aluminum, tin or lead. The anode electrode unit can include a layer of an active anode material, including a powder of the oxidizable metal, and where the layer of the active anode material can be coated on an electrically-conductive, chemically inactive anode current collector. The separator layer can be electrically insulating and able to be permeated with the electrolyte body to allow movement of ions between the anode and the cathode electrode units. The separator layer can include at least one of a glass, a fiber material, a filter paper or paper, or an electrically isolating and permeable material. The electrolyte body can include a liquid solution or a gel that is configured to permit a movement of ions between the anode and the cathode electrode units, accept ions for a battery from the anode electrode unit and/or supply ions to the cathode electrode unit. The electrolyte body can be configured to increase a level of a capacity of the cell by having a property that affects a rate of electron acceptance from an external circuit by having the cathode material of at least the powder of hydrated ruthenium oxide in the cell. The electrolyte body can include a composition that is configured to increase a level of a cell cycle lifetime of the cell by supporting cathode reactions that are reversible. The electrolyte body can include an aqueous solution of salts, organic acids, inorganic acids, and other additives. The electrolyte body can include a solution of an organic solvent and salts, additives, organic acids, and inorganic acids. The electrolyte body can be in a gel form, where the gel form can include gelling agents. The gelling agents can include at least one of agar or carboxymethyl cellulose.

Other aspects of the disclosure describe a device comprising an electrochemical cell, the electrochemical cell comprising: an anode electrode unit; a cathode electrode unit; and a first electrolyte body sandwiched between the anode and the electrode units. The cathode electrode unit includes a cathode material having at least a powder mixture of a powder of ruthenium oxide with activated carbon (AC) particles suspended in a second electrolyte body. The electrochemical cell is bendable and twistable to form a non-planar shape. The electrochemical cell is configured for a reduction-oxidation (redox) reaction to generate power at a surface of one or both of the electrode units.

Other aspects of the disclosure describe a method of fabricating a flexible electrochemical cell. The method includes: forming a backing layer of predetermined dimensions; identifying a predetermined active area on a surface of the backing layer; mixing a powder mixture from a powder of hydrated ruthenium oxide and a powder of activated carbon; preparing a paste from the powder mixture and an electrolyte; depositing the paste on the active area on the backing layer; applying the paste into the backing layer, thereby forming a cathode electrode unit, wherein the backing layer serves as a current collector; forming a metal anode electrode unit; forming a separator layer of predetermined dimensions from a permeable electrically insulating material; positioning the separator layer on the cathode electrode unit contiguous to the paste dispersed on the active area; impregnating the separator layer with the electrolyte; and attaching the metal anode electrode unit to the cathode electrode unit with the separator layer sandwiched therebetween.

One or more optional features may be included or involved with the electrochemical cell. The formation of the backing layer can include forming the backing layer of predetermined dimensions from a flexible metal, Mylar, plastic mesh or foil coated with an electrically conductive, chemically isolating polymer comprising polyaniline or polypyrrole. The application of the paste can include applying the paste into the active area on the backing foil, thereby forming the cathode electrode unit. The formation of the backing layer can involve forming the backing layer of predetermined dimensions from a flexible graphite mesh or carbon cloth. The metal anode electrode unit can be formed from a flexible sheet or foil of an oxidizable metal or the metal anode electrode unit can be formed from a flexible mesh of an oxidizable metal.

The details of one or more implementations are set further in the accompanying drawings and the description below. Other features will be apparent from the description and the drawings, and from the claims.

### BRIEF DESCRIPTION OF THE DRAWINGS

FIG. 1 illustrates an example of a cross-section of the battery cell.

FIG. 2 illustrates a top and/or bottom view of an example of the electrochemical energy cell.

FIG. 3 illustrates a diagram of an example of multi-layered coatings to be used as the anode or cathode in the electrochemical energy cell.

FIGS. 4A-4I illustrate a sequence of operations of an example method of manufacturing a prototype of one variant design of the electrochemical energy cell.

FIGS. 5A-5H-B illustrate a sequence of operations of an example method of manufacturing a prototype of one variant design of the electrochemical energy cell.

FIG. 6 illustrates a structure of an example of a “folded” design battery cell.

### EXAMPLE LIST OF PART NUMBERS IN DRAWINGS AND DETAILED DESCRIPTION

10 Electrochemical energy cell
12 “Standard design” cell
14 “Cathode-in-pocket” cell
16 “Anode-in-pocket” cell
18 “Folded” cell
20 Cathode electrode unit
21 Cathode electrode part for cell 12
22 Cathode material
24 Cathode current collector
25 Cathode current collector structural element for coated current collectors
26 Cathode current collector conductive element for coated current collectors
28 Cathode additives
29 Cathode paste
30 Coated cathode electrode unit
32 Coated cathode electrode unit coated face
34 Bottom seal layer for cell 12
36 Timer bottom seal layer for cell 12
37 Cutout of inner bottom seal layer for cell 12
38 Adhesive face for inner bottom seal layer for cell 12
40 Anode electrode unit
41 Anode electrode part for 12
42 Anode material
44 Anode current collector
45 Anode current collector structural element
46 Anode current collector conductive element
48 Anode additives
50 Coated anode structure
52 Coated face of a coated anode electrode unit
54 Top seal layer for cell 12
56 Inner top seal layer for cell 12
57 Cutout of the inner top seal layer for cell 12
58 Adhesive face of the inner top seal layer for cell 12
60 Electrolyte body
62 Electrolyte material
64 Gelled electrolyte material
66 Gelling agents
68 Electrolyte additives
70 Separator unit or layer or sheet
72 Separator material
74 Separator coating material
75 Separator center crease in cell 16
76 Separator center clearance in cell 16
77 Separator edge clearance in cell 16
78 Separator surfactant material
80 Cathode contact unit
82 Cathode contact strip
84 Epoxy on the bottom (cathode) contact in cell 12
90 Anode contact unit
92 Anode contact strip
94 Epoxy on top (anode) contact in cell 12
98 Zinc strip tab (protrusion) in cell 16
100 Sealing unit
101 Self-adhesive face of the bottom seal layer 34 for cell 12
102 Sealing material
103 Short edges of the separator sheet in cell 16
104 Side-sealing glue or epoxy for cell 12
105 Insulating glue or epoxy on edges 103 in cell 16
106 Heat-sealing on the sides for the separator in cell 16
107 Self-adhesive face of the top seal layer 54 in cell 12
108 Glue/epoxy sealing on the sides for the separator in cell 16
110 “Anode-in-separator” pocket for cell 16
112 Width of the anode in cell 16
114 Length of the anode in cell 16
120 Long edges of the cathode current collector in cell 16
122 Short edges of the cathode current collector in cell 16
124 Long edge clearances of the cathode current collector in cell 16
123 Folding line or center crease of the cathode current collector in cell 16
126 Short edge clearances of the cathode current collector in cell 16
127 “Unfolded” active area in cell 16
128 Epoxy along the edge clearances 124 in cell 16
129 Extra epoxy to seal the pocket “mouth” in cell 16
130 Separator extending over the anode to prevent contact between anode and cathode after folding in cell 16

### DETAILED DESCRIPTION OF EXAMPLE EMBODIMENTS

In the following description, for the purposes of explanation, numerous specific details are set forth in order to provide a thorough understanding of various example embodiments. It will be apparent, however, that some of these embodiments may be practiced without these specific details. The details of one or more embodiments are set forth in the accompanying drawings and the description below. Other features, objects, and aspects are apparent from the description and drawings, and from the claims.

A battery can “hold” energy for a long period of time when in a dormant state until electrons flow from the negative to the positive terminal. The chemical reaction can be launched once an electric load is created between the positive and negative terminals. In some batteries, an electrical current can be created when one material oxidizes, or gives up electrons, while another material immersed in an electrolyte becomes reduced, or gains electrons. In the reverse process, when a rechargeable battery is connected to an electrical power source, the flow of electrons can be opposite, so that the material that oxidizes during discharge gains electrons, while the other material gives up electrons. A non-rechargeable (single-use) battery is sometimes called a “primary battery.”

A capacitor can refer to a passive electronic component that stores energy in the form of an electrostatic field. In one form, for example, the capacitor can include a pair of conducting plates separated by an insulating material, e.g., a dielectric. The capacitance can be directly proportional to the surface area of the plates, and can be inversely proportional to the separation between the plates. The capacitance of a capacitor also depends on the dielectric constant of the substance separating the plates. Some capacitors rely on a phenomenon known as double-layer capacitance, where the positive and negative charges are collected on a particulate surface and the electrolyte it is immersed in, or on a phenomenon known as pseudocapacitance, where some electrode systems behave like capacitors in the sense that the potential they display is proportional to the amount of charge passed to or taken from the electrode.

Some embodiments may involve batteries, or galvanic cells, with all or some of the features described throughout this disclosure, which are designed and operated to be rechargeable. In some embodiments, these batteries may require low (e.g., below 1.5 volts) charge voltages, and may be safe in use. Some embodiments may involve batteries, or electrochemical energy cells, with all or some of the features described throughout this disclosure, which are designed and operated as primary (non-rechargeable) batteries. These batteries may be safe in use.

The described embodiments herein may have different physical designs for the battery. For example, there can be designs that use different current collector structures as a part of the anode or the cathode electrode unit, where numerous alternative physical structures can serve as an anode current collector that goes into the construction of the anode or as a cathode current collector that goes into the construction of the cathode.

The described embodiments herein may have various physical shapes for the battery. For example, one design results in a sandwich-like, single-layer battery; another design results in a “cathode-in-pocket” battery that effectively puts the cathode in a pocket made of the anode; another design results in an “anode-in-pocket” battery that effectively puts the anode in a pocket made of the cathode; and another design results in a “folded” battery that effectively folds the anode and cathode “around” each other in an interlocking manner. Other designs or combinations of these designs are within the scope of this disclosure.

The described embodiments herein may have a coated structure as a combined cathode current collector and cathode material (e.g., the coated structure by itself may be the entire cathode electrode unit). The described embodiments herein may have a coated structure as a combined anode current collector and cathode material (e.g., the coated structure by itself may be the entire anode electrode unit). Other coated structures may be within the scope of this disclosure.

The described embodiments herein may have different chemical designs and compositions for the battery. For example, there may be various additives (or combinations of the various additives) to the cathode material, anode material, and/or the electrolyte material.

The terms for “electrochemical energy cell,” “electrochemical cell,” “galvanic cell,” or “battery,” for example, can be used interchangeably. In some embodiments, an “electrochemical cell” or “electrochemical energy cell” can also imply “hybrid battery/capacitor cell.”

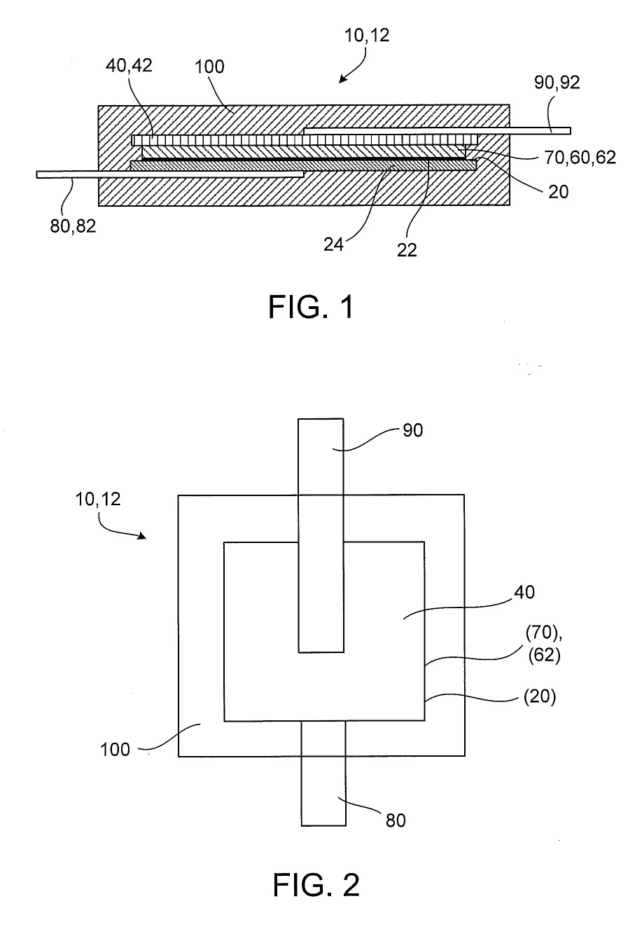

FIG. 1 illustrates an electrochemical energy cell 10/“Standard design” cell 12 that includes a cathode electrode unit 20, cathode material 22, a cathode current collector 24, an anode electrode unit 40/anode material 42, an electrolyte body 60/electrolyte material 62/separator unit or layer or sheet 70, and a cathode contact unit 80/cathode contact strip 82 and an anode contact unit 90/anode contact strip 92 with a sealing unit 100.

FIG. 2 illustrates an electrochemical energy cell 10/“Standard design” cell 12 that includes a cathode electrode unit 20, an anode electrode unit 40, electrolyte material 62/separator unit or layer or sheet 70, and a cathode contact unit 80 and an anode contact unit 90 with a sealing unit 100.

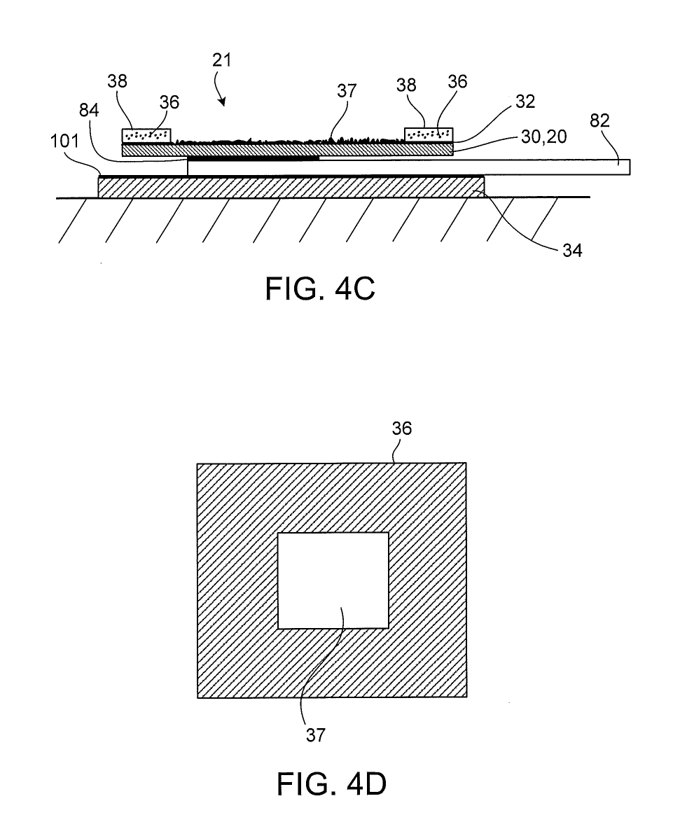

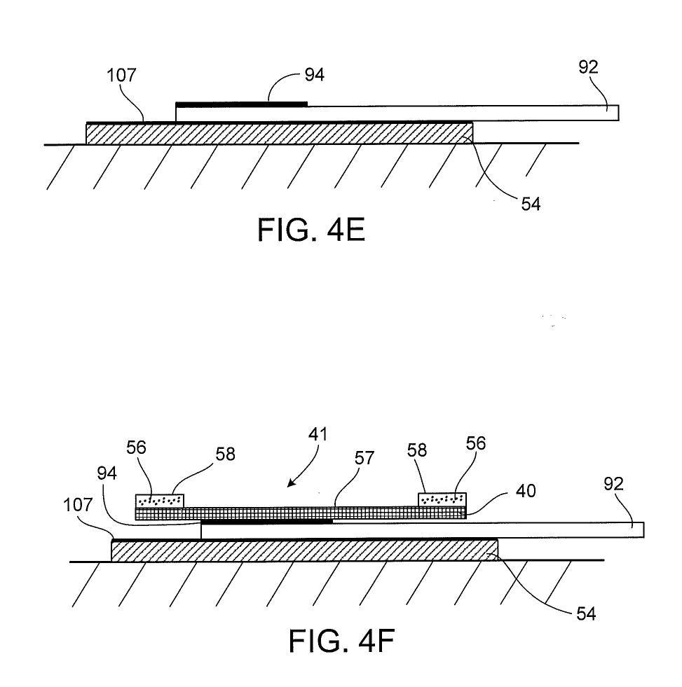

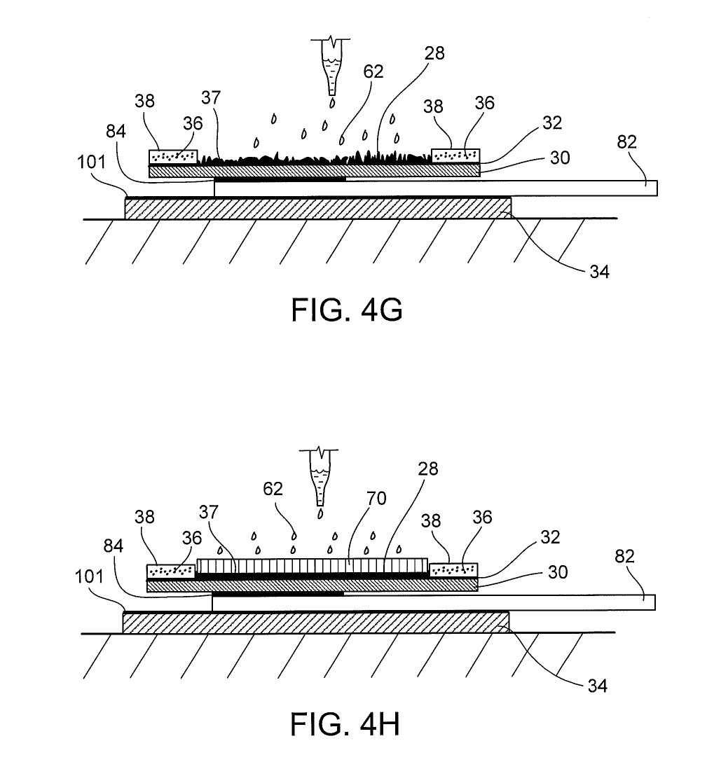

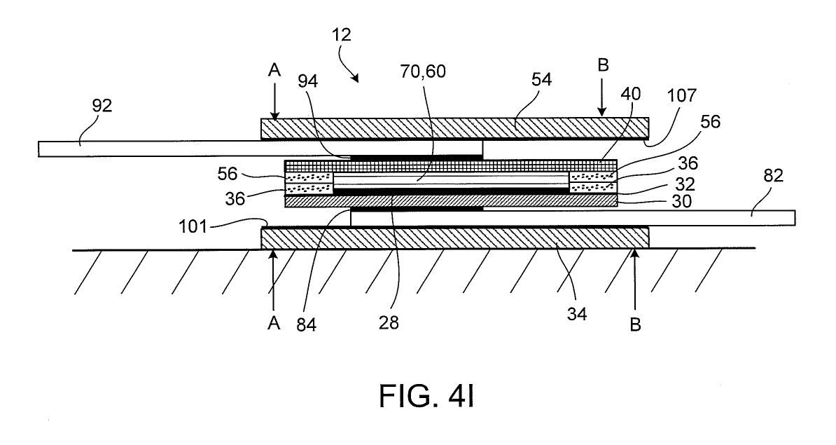

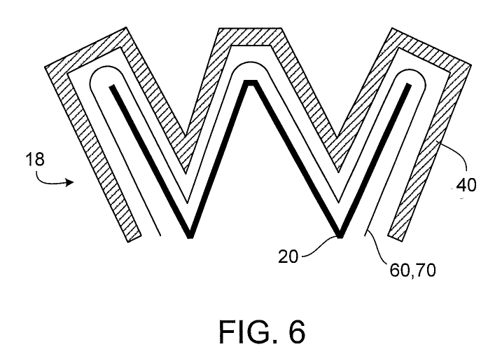

FIGS. 4A-4I illustrate a sequence of operations of an example method of manufacturing a prototype of one variant design of the electrochemical energy cell, and FIG. 6 illustrates a structure of an example of a “folded” design battery cell. FIG. 6 includes a “folded” design battery cell 18 with a cathode electrode unit 20, an anode electrode unit 40 and a separator structure 70.

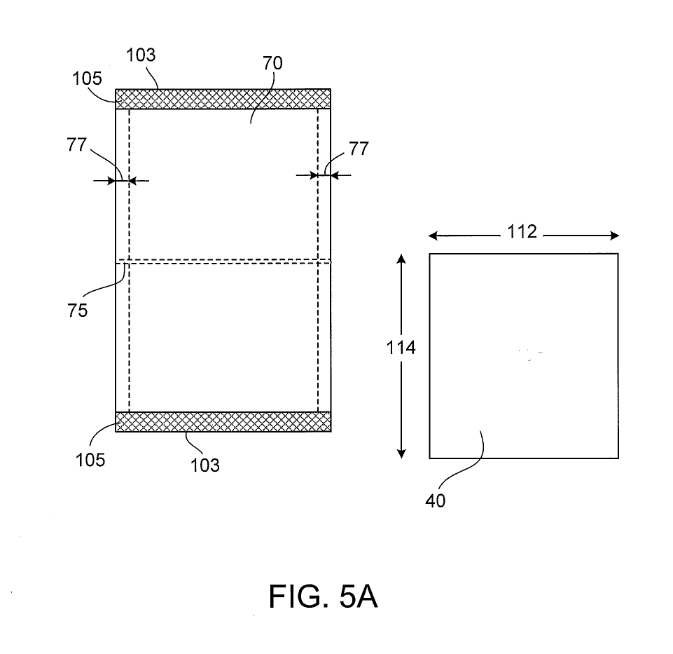

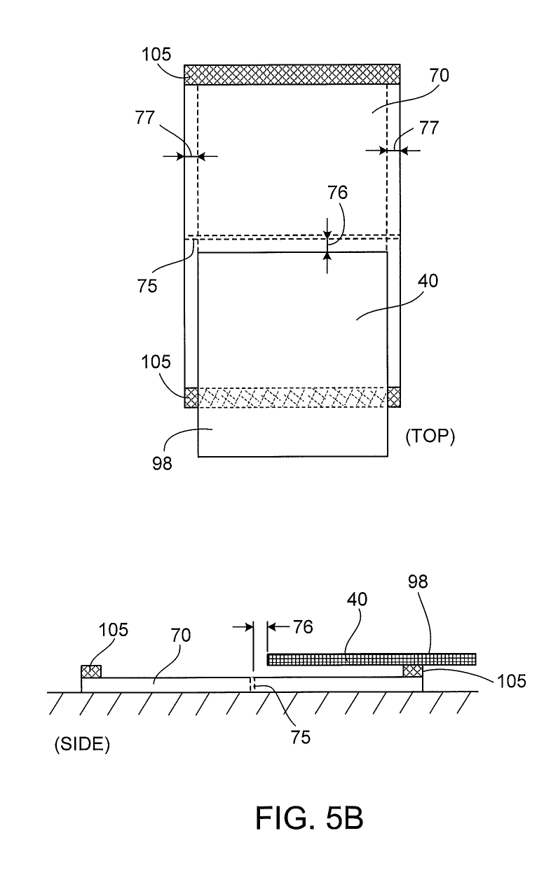

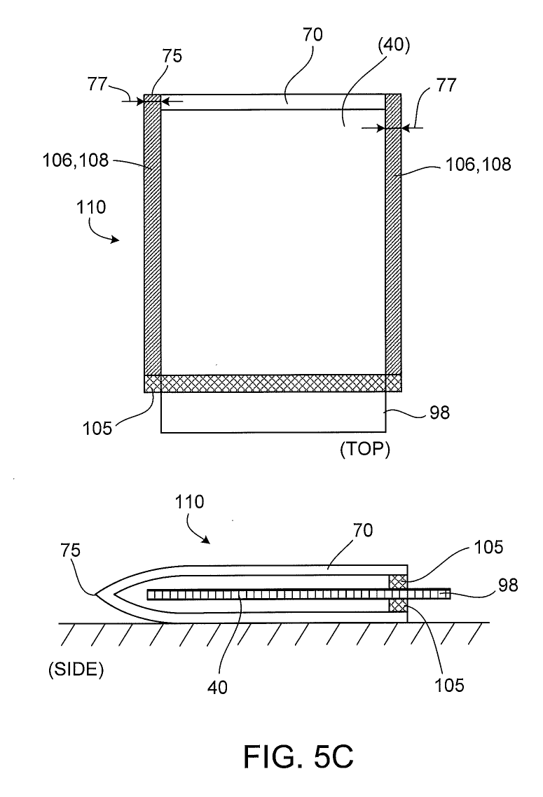

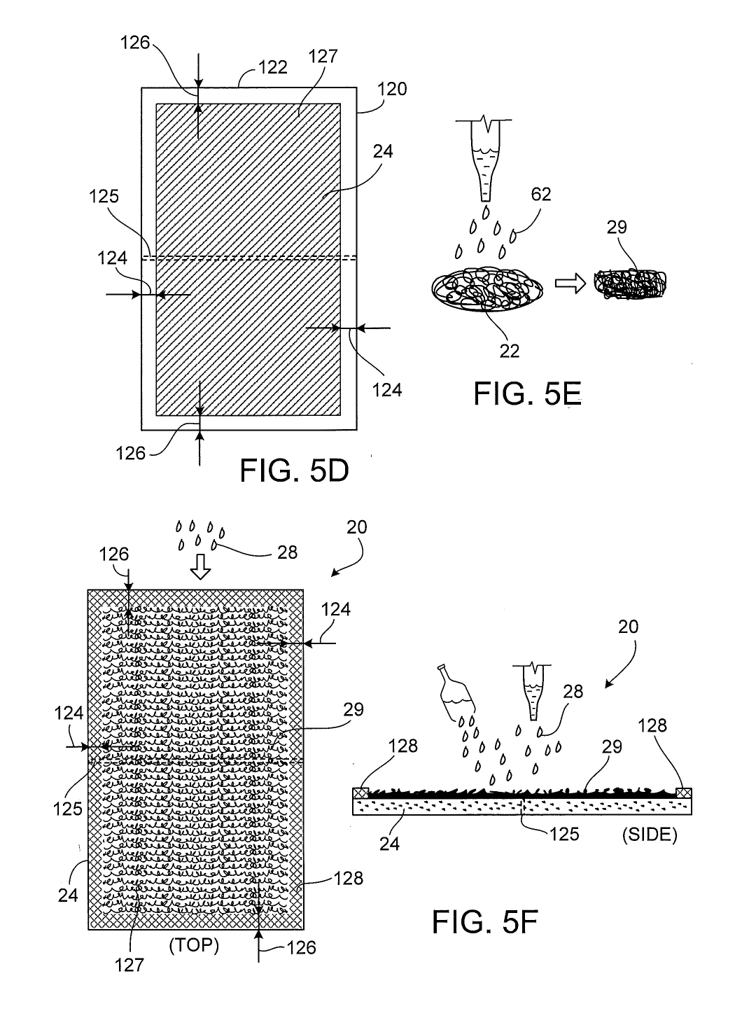

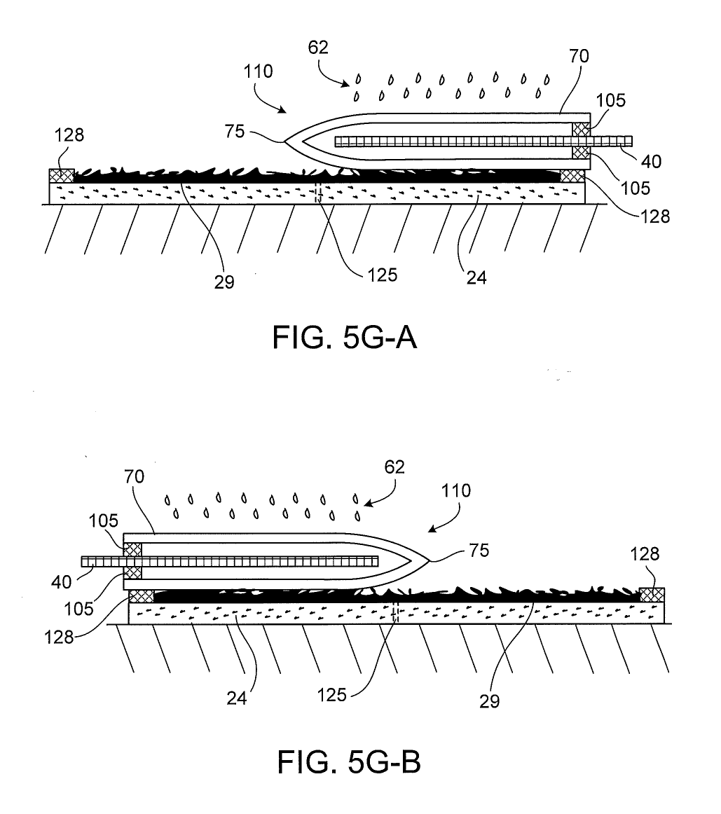

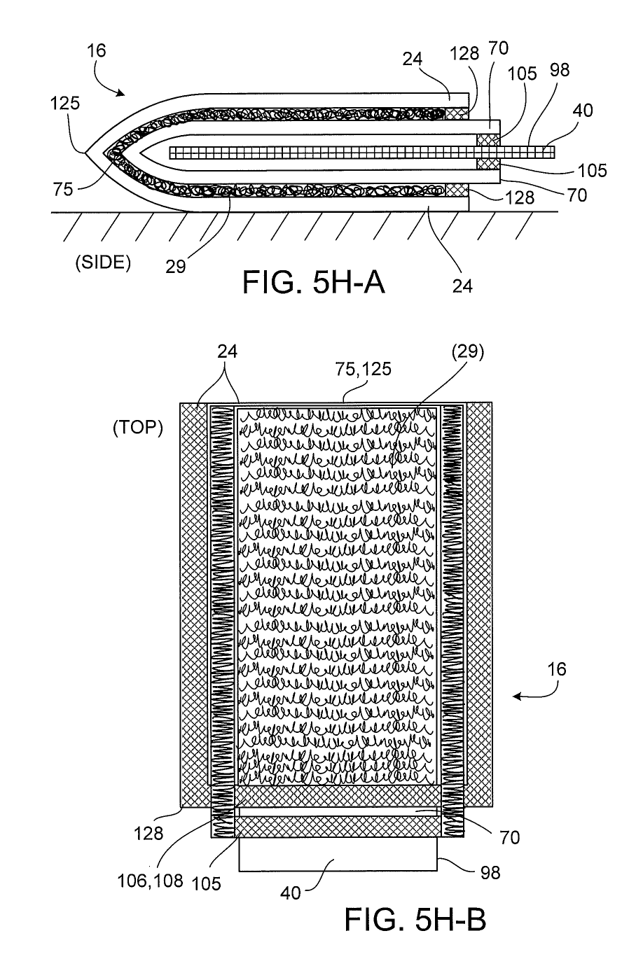

Referring to FIGS. 1, 2, 4A-4I, and 6, a flexible thin electrochemical cell is implementable as a flexible thin battery or a flexible thin rechargeable battery. This battery cell may be fabricated in any of a number of different form factors. For instance, the battery cell may be formed in a “standard planar” structure, referred to as a standard-design cell 12, as shown in FIG. 1 and FIGS. 4A-4I. The battery cell may also be devised in the form of a pocket with the cathode inside, referred to as the cathode-in pocket cell 14. The battery cell may also be devised in the form of a pocket with the anode inside, referred to as the anode-in-pocket cell 16, as shown in FIGS. 5A-5H-B. The battery cell may also be devised in the form of a folded structure, referred to as the folded cell 18. In any of these forms, the electrochemical energy cell may be a flexible, thin, rechargeable or primary energy device, and can be used in low-power, low-maintenance applications, which may be substantially planar as shown in FIG. 2, or may be flexibly bent and deformed, depending on the particular application. The form factor of the planar electrochemical energy cell may be mainly square or rectangular, as depicted in FIGS. 2, 4A-4I, 5A-5H-B, or any other two-dimensional geometrical form, and can conform to the particular application.

In various embodiments, the electrochemical energy cell can include, for example, the following components.

a. A cathode electrode unit 20, comprising either:
i. A cathode current collector structure 24 and a cathode active material 22, and in some embodiments, cathode additives 28, spread over a cathode current collector 24 by a mechanical method, or
ii. A coated cathode structure 30, formed by the cathode active material 22 and in some embodiments, cathode additives 28, coated on the cathode current collector 24 through the use of coating, dyeing or printing methods such as Langmuir-Blodgett based coating, ink jet printing, screen-printing, aerosol-based dyeing, airbrushing, spray deposition techniques, and any other such applicable methods, or
iii. Multiple layers of the above;

b. A separator unit 70;

c. An electrolyte body 60, comprising an electrolyte material 62 and possibly electrolyte additives as described in Table 1.

d. An anode electrode unit 40, comprising either:
i. A single thin foil or mesh of conductive, oxidizable metal, made of the anode material 42, serving as both material and as the anode current collector (not shown in the figure as a separate structure, but could be a separate structure) or
ii. An anode current collector structure (although not shown in the figure because the active material 42 is also the current collector) and the anode active material 42, and in some embodiments, anode additives as described in Table 1, spread over cathode current collector 24 by a mechanical method, or
iii. A coated anode structure, formed by the anode active material 42 and in some embodiments, anode additives as described in Table 1, coated on an anode current collector through the use of coating, dyeing or printing methods such as Langmuir-Blodgett based coating, ink-jet printing, screen-printing, aerosol-based dyeing, airbrushing, thermal spray coating, spray coating techniques, gravure printing, and any other such applicable methods, or
iv. A slab or patty of conductive, oxidizable metal, formed by using pressure on a powder of this metal, and, possibly, additive materials, used either by itself as the complete anode electrode unit 40, or as the anode active material 42 by being placed on an anode current collector structure, or
iv. Multiple layers of the above.

e. A cathode contact unit 80 and an anode contact unit 90,

f. A sealing and packaging unit or method 100.

The formation of these components shall be described in detail in this Section. It should be understood that any variants of the cathode electrode unit 20, separator unit 70, electrolyte body 60 and anode electrode unit 40 may be used in any combination to form the thin electrochemical cell 10. The fabrication methods to obtain batteries with different form factors are also described in this section. It should be understood that any variants of the cathode electrode unit 20, separator unit 70, electrolyte body 60 and anode electrode unit 40 may be used in any combination in the fabrication of any of the form factors described.

The thin electrochemical energy cell can include, for example, one or more of the following features:

a. The cathode active material 22 may be formed by the compounding of activated carbon (abbreviation: AC, chemical composition: C) particles with hydrated ruthenium oxide particles. Additionally, the cathode active material 22 may be formed by the compounding of carbon nanotube (abbreviation: CNT, chemical composition: C) or graphene particles with hydrated ruthenium oxide particles. Note that the chemical composition RuO₂.xH₂O, can refers to “ruthenium oxide hydrate” or “hydrated ruthenium oxide”. Further, note that from here on, the term “particles” may mean “particles or nanoparticles”. The volume ratios of the materials in either the AC:RuO₂.xH₂O mixture or the CNT:RuO₂.xH₂O mixture may vary from 0%:100% to 100%:0%, depending on the requirements for the battery. For one embodiment, for example, this ratio may be 50%:50% for either mixture. Additionally, it is possible to form the cathode active material 22 by compounding both AC and CNT with RuO₂.xH₂O, or by compounding any other conductivity-enhancing additive with RuO₂.xH₂O.

b. The cathode material additives 28 may include Nafion™, iridium oxide, indium oxide, sodium chloride, platinum black, palladium, Agar, metal functionalized carbon-nanotubes (Ni-plated carbon nanotubes for example), titanium dioxide, tungsten carbide, or other materials. When Nafion™ is utilized, for example, it may be used in the form of a solution where the concentration may be 5% by weight or less. If iridium oxide, indium oxide, sodium chloride or similar materials are used, for example, the amount used may be 10 mg or less per each cm² of active battery area.

c. The cathode current collector structure 24 may include one or more of the following structures and/or materials:
a. a sheet of thin, flexible graphite foil;
b. a sheet of thin, flexible graphite mesh (or carbon fiber cloth);
c. a sheet of thin, flexible metal such as aluminum foil, coated with a chemically inactive and isolating, electrically conductive polymer such as polyaniline or polypyrrole, or any other coating material that has similar chemical insulation/electrical conduction properties, such as carbon paint;
d. a sheet of thin, flexible metal mesh, made from for instance copper or aluminum, coated with a chemically inactive and isolating, electrically conductive polymer such as polyaniline or polypyrrole, or any other coating material that has similar chemical insulation/electrical conduction properties, such as carbon paint;
e. a thin, flexible sheet of Mylar or other similar plastic, or any other thin, flexible material whether in sheet, foil, mesh or cloth form, coated with a chemically inactive and isolating, electrically conductive polymer such as polyaniline or polypyrrole, or any other coating material that has similar chemical insulation/electrical conduction properties, such as carbon paint; or
f. any other thin, flexible, sheet-form material that can provide structural support to a planar battery or serve as a substrate for the cathode active material to be coated on or spread on, which can be electrically conductive and chemically inert for the purposes of the battery reactions.

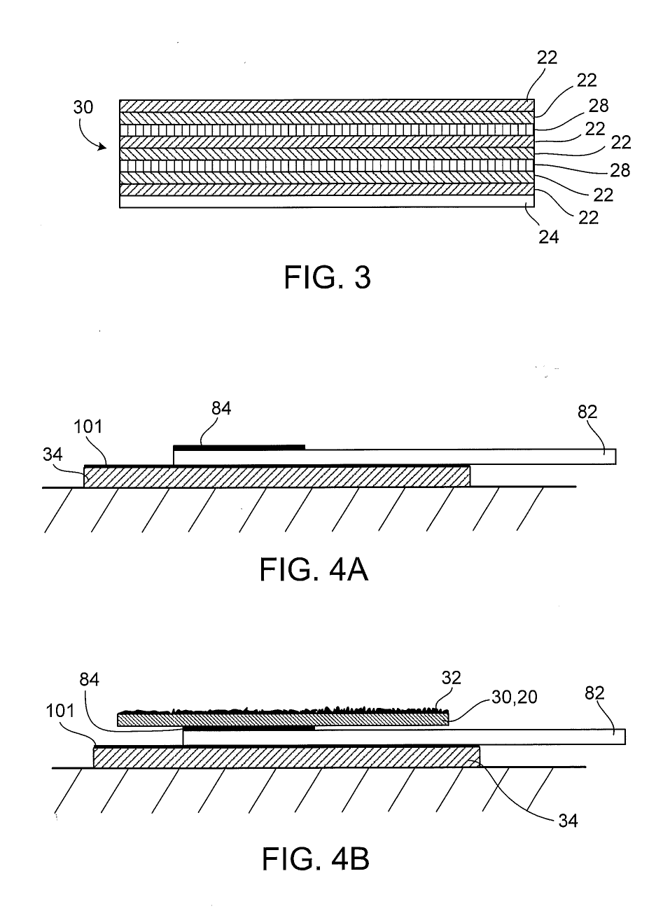

d. If the coated cathode structure 30 is used in the battery construction, it may be prepared in one of the following structures:
a. a single-layer coating of a mixture of the cathode active material 22 and optional cathode additives 28 on the cathode current collector 24, which may involve any of the variations described herein,
b. multiple-layers of coating of a mixture of the cathode active material 22 and optional cathode additives 28 on the cathode current collector 24, which may involve any of the variations described herein,
c. multiple alternating coating layers, for instance one or several layer(s) of a mixture of the cathode active material 22 followed by one or several layer(s) of cathode additives 28, in which the alternating-layer structure may itself be repeated. For instance, in an example embodiment shown in FIG. 3, two layers of coating of the cathode active material 22 is followed by one layer of cathode additive 28, followed by these three layers (22, 22, 28) repeated, followed by another two layers of cathode active material 22,
d. single or multiple layers of RuO₂.xH₂O-only coating, possibly followed by or alternated with single or multiple layers of AC or CNT or other conductivity-enhancing additive coating, possibly followed by or alternated with single or multiple layers of other cathode additives in Table 1 as described herein.

e. The electrolyte material 62 may be a mixture including ethylene glycol, glycerol, boric acid, citric acid, hydrochloric acid, other weak or strong acids, sodium citrate, zinc chloride, zinc acetate, zinc perchlorate, ammonium chloride, ammonium hydroxide, sodium chloride, or other salts. Not all of these components may be present in the particular electrolyte composition that is implemented. The mixture can be in the range of pH 0 to pH 7 (i.e. acidic). The mixture can be in the range of pH 7 to pH 14 (i.e. basic). As an example, the citric acid may be prepared with 400 mg of citric acid crystals dissolved in 100 cm³ of water, or with 10 g of citric acid crystals dissolved in 100 cm³ of water, or with 50 g of citric acid crystals dissolved in 100 cm³ of water. The boric acid may be prepared with 5 grams or less of boric acid crystals dissolved in 100 cm³ of water. The hydrochloric acid may be 37% by weight hydrochloric acid. An example embodiment of the electrolyte may be prepared with the following volume percentages: 25% hydrochloric acid (at 37% by weight concentration), 33.75% ethylene glycol, 27.75% boric acid and 13.5% citric acid. Other embodiments may be selected from among the electrolyte composition options described herein. A few drops of hydrochloric acid can be added to adjust the pH to more acidic values. A few drops of ammonium hydroxide can be added to adjust the pH to less acidic values.

f. The electrolyte additives 68 may be amounts of polyaniline, polypyrrole, zinc oxide, indium oxide, iridium oxide, various other metal oxides, sodium chloride, sodium citrate, sodium phosphate, potassium phosphate, various other salts, agar, sucrose, glucose, low-molecular-weight polyethylene glycol, or Nafion™, among others.

g. The electrolyte may be present in the form of a gel, the gelled electrolyte material 64, created from an electrolyte material 62 as the liquid base and gelling agents 68. The gelling agent 68 may be one or a mixture of any of the following materials: Agar, cellulose, carboxymethyl cellulose, methyl cellulose, pectin, gelatin, sorbitol, glycerol, carrageenan, polyethylene glycol and other materials with thickening or colloid properties. Surfactants may be included to aid with the formation of a flat, thin gel and for better connection between the gel and electrode surfaces.

h. The separator unit or separator layer 70 may comprise of a thin, flexible sheet, made of any material, referred to as the separator material 72, that is electrically insulating, porous enough to allow for ion transport, and is capable of absorbing, or being impregnated by, the electrolyte material 62 without being damaged by the electrolyte material. In some embodiments, for example, the following materials may be used as separator material 72: Glass fiber filter paper, Nafion™ in sheet form, separators available from Celgard™, separators available from AMS™, separators from other separator suppliers, tissue paper, and cheesecloth. The separator material 72 may also be made of the gelled electrolyte material 64 itself as described above if that option is exercised, produced for instance by mixing any gelling agent 66 listed above or others with water, electrolyte material 62, ethylene glycol or glycerol, or any mixture of these liquids. In this case, the separator unit 70 is made of a thin slice of the gel electrolyte material 64. The separator unit 70 may also be a combination of alternating layers of the gelled electrolyte material 64 and separator material 72, where both the gelled electrolyte material 64 and the separator material 72 may be chosen from the options described herein.

i. The anode active material 42 may include:
a. A thin, flexible sheet of an oxidizable metal, such as zinc, aluminum, or lead, in which case this sheet also forms the anode current collector 44 and anode electrode unit 40 by itself; or
b. A powder of an oxidizable metal such as zinc, optionally compounded with an anode additive listed in Table 1, or others such as iridium oxide, indium oxide, zinc oxide, polyaniline, or polypyrrole in powder or solution form, or
c. A powder of an oxidizable metal such as zinc, optionally compounded with an anode additive listed in Table 1, pressed into a patty or slab by use of high pressure.

j. The anode current collector structure if in use, for example, may include:
a. a sheet of thin, flexible graphite foil; or
b. a sheet of thin, flexible graphite mesh (or carbon fiber cloth); or
c. a sheet of thin, flexible metal such as aluminum foil, coated with a chemically inactive and insulating, electrically conductive polymer such as polyaniline or polypyrrole, or any other coating material that has similar chemical insulation/electrical conduction properties, such as carbon paint;
d. a sheet of thin, flexible metal mesh, made from for instance copper or aluminum, coated with a chemically inactive and isolating, electrically conductive polymer such as polyaniline or polypyrrole, or any other coating materials that have similar chemical isolation/electrical conduction properties, such as carbon paint; or
e. a thin, flexible sheet of Mylar or other similar plastic materials, or any other thin, flexible material whether in sheet, foil, mesh or cloth form, coated with a chemically inactive and isolating, electrically conductive polymer such as polyaniline or polypyrrole, or any other coating materials that have similar chemical insulation/electrical conduction properties, such as carbon paint, or
f. any other thin, flexible, sheet-form materials that can provide structural support to a planar battery or serve as a substrate for the anode active material to be coated on or spread on, which will be electrically conductive and chemically inert for the purposes of the battery reactions.

k. When used, the sealing unit 100 can be made of several parts, from an electrically insulating and chemically isolating material, such as a thin plastic foil, or a sheet of laminating material or a sheet of plastic foil treated for gas and liquid impermeability, which may be self-adhesive on one side for ease of battery fabrication.

The thin electrochemical energy cell can be fabricated in several form factors (as described herein) using any of the possible combinations of cathode electrode unit 20, anode electrode unit 40, separator unit 70, and electrolyte body 60, along with (if necessary; cathode and anode contact units 80 and 90 respectively, and a sealing unit 100 if necessitated by the structure.

Referring to FIGS. 4A-4I, an example method for the assemblage of the electrochemical energy cell is shown. This example method, in particular, is for the assemblage of the type “standard design cell” 12, using the following:

a. the coated cathode structure 30 as the cathode electrode unit 20,

b. a foil of the anode material 42 as the anode electrode unit 40, and

c. a layer of filter paper as the separator unit 70.

It should be understood that a method similar to those shown in FIGS. 4A-4I and described below can be used to construct the electrochemical energy cell 10 with all of the alternate versions of the cathode electrode units, anode electrode units, separator units, packaging method or electrolyte materials described herein.

Referring to FIG. 4A, the bottom seal layer 34 is cut from the sealing unit material 102 and placed with the self-adhesive face (if applicable) facing upwards on a level surface. A contact strip 82 is placed on the bottom seal layer 34 with one end in the central area of the layer and the other end extending past the edge of the bottom seal layer 34. The contact strip 82 can be securely adhered to the bottom seal layer 34, which includes a self-adhesive face 101 on the bottom sealing layer 34. Further, a conductive epoxy layer 84 is spread over the contact strip 82 in the portion of the contact strip 82 that is near the center of the bottom seal layer 34.

Further, referring to FIG. 4B, the coated cathode structure 30, acting as the cathode electrode unit 20, is placed on the center of the bottom seal layer 34, with the coated face 32 facing upwards, to cover the end section of the contact strip 82 that is near the center of the bottom seal layer 34, and is adhered thereto through epoxy layer 84.

Further, referring to FIG. 4C, the inner seal frame layer 36 is cut from the sealing material 100 and is placed on the coated cathode structure 30 so that the cutout 37 thereof is centered with the coated cathode structure 30. The inner seal frame 36 is substantially of the same form factor as the battery cell 12, with a cutout 37 in the center, which is square in the embodiments, as shown in FIG. 4D. If applicable, the self-adhesive surface 38 of the inner seal frame 36 faces upward. The cathode electrode part 21 shown in FIG. 4C is thus formed.

Referring to FIG. 4E, the top seal layer 54 is cut from the sealing unit material 100 and is placed with the self-adhesive face 107 (if applicable) facing upwards on a level surface. A contact strip 92 is placed on the top seal layer 54 with one end in the central area of the layer and the other end extending past the edge of the top seal layer 54. The contact strip 92 can be securely adhered to the top seal layer 54. Further, a conductive epoxy layer 94 is spread over the contact strip 92 in the portion of the contact strip 92 that is near the center of the top seal layer 54.

Further, referring to FIG. 4F, a foil of the anode electrode material 42 is cut to act as the anode electrode unit 40, and is placed on the center of the top seal layer 54, to cover the end section of the contact strip 92 that is near the center of the top seal layer 54, and is adhered thereto through epoxy layer 94. The inner seal frame layer 56 is cut from the sealing material 100 and is placed on the anode electrode unit 40 so that the cutout 57 thereof is centered with the anode electrode unit 40. If applicable, the self-adhesive surface 58 of the inner seal frame 56 faces upward. The anode electrode part 41 shown in FIG. 4F is thus formed.

Further, as shown in FIG. 4G, 1 to 10 mg/cm² of activated carbon particles and 1 to 10 mg/cm² of sodium chloride and 1 to 10 mg/cm² of agar is sprinkled over the exposed area of the coated cathode structure 30 in the cathode electrode part 21. The sodium chloride and agar serve as the electrolyte additive 68. The activated carbon serves as the cathode additive 28. A small amount of the electrolyte material 62 is further dropped on this exposed area to wet the additives. Depending on the particular electrolyte, different additives may be used or omitted.

Further referring to FIG. 4H, the separator layer 70 is placed on the cathode electrode part 21 so as to cover the cutout 37. The separator 70 is pressed very gently against the cathode electrode part to assure even contact without damaging the coating. Further referring to FIG. 4H, the separator layer 70 is impregnated with the electrolyte material 62.

Further, referring to FIG. 4I, the anode electrode part 41 is turned so that the previously-top surface (if applicable, the adhesive face 58) faces downward, and the top seal surface 54 faces up, and is placed on the cathode electrode part 21 to sandwich the separator 70 between. If the sealing material 100 does not have a self-adhesive face (and optionally if it does have a self-adhesive surface), a frame is made of an insulating glue or epoxy material along the edges of both the cathode electrode part 21 and anode electrode part 41 to seal the separator layer 70 impregnated with the electrolyte material 62 entirely within the packaging. The protruding ends of the contact strips 82 and 92 point in opposite directions and extend external to the structure. The entire structure can be pressed tightly along the edges, as shown by arrows A-A and B-B, to ensure adhesion and a complete seal to form the sealing package. The entire battery cell then can be pressed throughout the entire surface to ensure full contact of the materials. Further, heat-sealing or sealing by adhesive tape may be performed along the perimeter of the structure. FIG. 2, for example, shows the resulting structure (plan view) of the structure formed by the techniques presented in FIGS. 4A-4I.

FIGS. 5A-5H-B illustrate an example of a method for the assemblage of the electrochemical energy cell 10. This example, in particular, is for the assemblage of the type “anode-in-pocket cell” 16, using at least the following:
a. a cathode current collector layer 24, in the form of a sheet of thin, flexible graphite mesh (or carbon fiber cloth), along with some powdered cathode material 22, reinforced with some Nafion™, for example, as the cathode additive 28, as the cathode electrode unit 20;
b. a foil of the anode material 42 as the anode electrode unit 40; and
c. a sheet of Celgard™ material, for example, as the separator unit 70.

It should be understood that a method similar to those shown in FIGS. 5A-5F and described below can be used to construct the electrochemical energy cell in the “anode-in-pocket” type 16 with the alternate versions of the cathode electrode units, anode electrode units, separator units, packaging method or electrolyte materials described herein.

Referring to FIG. 5A, which is a top view, the separator sheet 70 is cut in a rectangular form-factor and laid flat on a clean level surface. The separator sheet 70 is folded in the middle of the long direction and unfolded, leaving a center crease mark 75 in the middle as shown in FIG. 5A. A sheet to form the anode electrode unit 40 is cut from the anode material 42 in dimensions to fit in half of the separator sheet 70 as shown in the FIG. 5A. The width 112 of the anode electrode unit 40 plus the two long-edge clearances 77 can be equal to the length of the short edge 103 of the separator sheet 70. The length 114 of the anode electrode unit 40 can be slightly longer than half of the length of the separator sheet 70. Strips of insulating epoxy or glue 105 can be spread over the short edges 103 of the separator sheet 70, with a width of around 2-3 mm.

Further referring to FIG. 5B, TOP and SIDE views, the anode electrode unit 40 is placed on half of the separator sheet 70, with a center clearance 76 (of the order of 1-2 mm) from the center crease 75, and with edge clearances 77 (of the order of mm) from the long edges of the separator sheet 70, as shown in the figure. One edge 98 of the anode electrode unit 40 protrudes out of one of the short edges 103 of the separator sheet 70. If the separator material 72 is not suitable for heat-sealing, at this step, optionally, a layer of non-conductive epoxy or glue can be spread along the edges on the edge clearances 77.

In FIG. 5C showing the TOP and SIDE views, the separator unit 70 is folded once more across the center crease 75, which becomes the folded edge 75, and the anode-in-separator pocket 110, which is a pocket of the separator material 72 with the anode electrode unit 40 within, is formed. One edge 98 of the anode electrode unit is protruding to the outside of the anode-in-separator pocket 110. The anode-in-separator pocket 110 is firmly pressed along the insulating epoxy areas to ensure full sealing. The edges 77 are heat-sealed (106) if the separator material is suitable for heat-sealing (e.g., Celgard™) or pressed along the optional layer of non-conductive epoxy or glue (108) if that option has been used.

Referring to FIG. 5D, a rectangular sheet is cut from an appropriate material to form the cathode current collector layer 24, shorter in the long edge 120 than the long edge of the separator sheet 70 and longer in the short edge 122 than the short edge of the separator sheet 70. The dimensions are such that the width between the two long edge clearances 124 is equal to the width 112 of the anode unit 70. The unfolded active area 127 is thus bounded by the long edge clearances 124 and short edge clearances 126 of the cathode current collector layer 24. The cathode current collector layer 24 is folded in the center of the long edge 1 and unfolded to make the center crease mark 125.

Further referring to FIG. 5E, an amount of the electrolyte material 62 is mixed with an amount of the powdered cathode material 22 to form a paste 29 which is considered a cathode material paste. The amount of electrolyte may be 0.1 to 0.7 mL per cm² of unfolded active area 127, for example. The amount of powdered cathode material 22 may be 0.1 g or less per cm² of unfolded active area 127, for example.

In FIG. 5F showing TOP and SIDE views, the paste 29 is deposited on the active area 127 of the cathode current collector layer 24, and is spread throughout this area. Optionally, 0.1 mL or less per cm² of the unfolded active area 127 of a solution of Nafion™, for example, 5% or less by weight, can be dropped over the paste 29 as a cathode additive 28 with the assistance of a pipette, and some time can be allowed to pass for the solvent to evaporate. Optionally, 20 mg or less per cm² of the active area 127 of sodium chloride can be mixed in the paste 29 as another cathode additive 28, for example. Insulating epoxy or glue 128 is spread in preparation for the next step along the short edge clearances 126 and long edge clearances 124. This forms the cathode electrode unit 20.

Referring to FIG. 5G-A, the anode-in-separator pocket 110 is placed on the cathode current collector layer 24 over the paste 29, so that the folded edge 75 is aligned with the center crease mark 125 of the cathode current collector layer and the short edge centers of pocket 110 are aligned. Less than 0.1 mL/cm² of the unfolded active area 127 of electrolyte material 62 can be dropped over the separator to impregnate it, for example. Then, as shown in FIG. 5G-B, the anode-in-separator pocket 110 is turned over “around” the folded edge so that its other face is exposed to be impregnated with a similar amount of electrolyte material 62.

In FIG. 5H-A, which shows the SIDE view, and FIG. 5H-B, which shows the TOP and SIDE view, the cathode current collector layer 24 is folded along the center crease mark 125, which becomes the folded edge 125. This forms the anode-in-pocket cell 16. The edges 120 of the cathode current collector material is pressed gently to make sure that the insulating epoxy or glue 128 spread along those edges fully adhere and provide side sealing. Some extra insulating epoxy or glue 129 is spread over the protruding edges 130 of the separator to glue the protruding tab 98 of the anode current collector to the short edge 122 of the cathode current collector, and to seal and package the electrolyte and cathode material within the pocket. In this anode-in-pocket cell 16, the protruding tab 98 serves as the anode contact unit. The full “back” or outside surface of the cathode current collector layer 24 may serve as the cathode contact unit. Optionally, to preserve the cathode current collector layer 24 from wear and tear, conducting epoxy may be used to connect a cathode contact unit in the form of a metallic strip or wire to the “back” or outside surface of the cathode current collector layer.

It should be understood that a similar and parallel method of fabrication may be used to construct the “cathode-in-pocket” cell 14, swapping the anode and cathode current collectors and materials in the techniques described above in FIGS. 5A through 5H-B.

Another alternative method of constructing a cell, called a “folded cell” 18, involves forming a multiple-layered battery structure by folding anode electrode units 40 and cathode electrode units around each other, and separating them with one or more separator structures 70, as shown schematically in the example of FIG. 6. The requisite cell sealing is omitted from FIG. 6 for reasons of clarity. Although FIG. 6 shows a four-fold structure, any number of folds can be implemented. The method of fabricating this kind of cell can be configured to and modified for many variants of anode electrode units, cathode electrode units, and separator units.

Other example embodiments may include one or more of the other listed features in Table 1.

TABLE 1
Examples of other embodiments.

Cathode Current Collectors
Conductive Forms of Carbon:
Graphite Foil
Carbon fiber veil or fiberglass
Carbon Fiber Rods
Carbon Nanofoam
Carbon Nanotubes (CNTs), such as rods, etc.
(not only as additives, but also in a sheet
that may be referred to as “buckypaper”)
Carbon Cloth (Spectracarb)
CNTs entangled in carbon fibers
Carbon-based inks, etc. on various substrates
insulators (Mylar, other plastic, glass,
clothing material)
conductors
foils (aluminum, copper, lead, etc.)
meshes (copper, al most common) with
various opening sizes and thicknesses
These inks can be graphene based,
CNT based, carbon black based, carbon fiber
based, etc.
Conductive polymers coated onto insulators
or conductors (as above):
Polyaniline, polypyrrole
Additives for RuO₂•xH₂O Cathode or Zinc
or other Metal Anode (Compounding)
Various forms of Carbon:
Activated Carbon
Carbon Black
CNTs
Carbon Fiber
Graphene
Non-oxidizing metals such as gold,
Metals such as aluminum, nickel, tin, and others
Additives for ionic or electrical conductivity
(e.g., Nafion ™)
Additives for other purposes, such as cycling
or lower internal resistance:
Agar
Sugar
Sorbitol
Indium oxide, iridium oxide, bismuth, indium,
palladium, platinum
Metal-functionalized carbon nanotubes
Titanium dioxide, zinc oxide
Tungsten carbide
Sodium chloride, etc.
Crystalline boric acid, acetic acid, citric acid,
other anhydrous acide materials
Polyaniline or polypyrrole
Surfactants, e.g., sodium dodecyl sulfate,
polyethylene glycol

In some embodiments, a multiple-layer cathode structure (e.g., folded mesh, carbon veil, or layers of the same, as well as multiple-layer coatings on a single cathode current collector) can add capacity with layer thickness. This multiple-layer cathode structure can lead to extremely high capacities.

### Examples of Various Embodiments

The described features may also be implemented in one or more combinations of the following embodiments.

Some battery and capacitor designs might incorporate a structure serving as a “current collector.” The anode and cathode electrode units have separate current collectors, as the anode current collector and cathode current collector, respectively. This structure can to be electrically conductive, and it may be chemically inert for the purposes of the battery operation. In the battery, this structure can be in electrical contact with a separate anode or cathode material as applicable to collect electrons from the battery operation and conduct them to the outside load (in the case of an anode current collector) or supply electrons from the outside to the battery operation (in the case of a cathode current collector). Also, positive and negative lead contacts can be electrically connected to the cathode electrode unit and the anode electrode unit, respectively.

Some embodiments may relate to a high capacitance battery or electrochemical energy cell, in which the battery or cell can include, as a cathode material, a powdery mixture of hydrated ruthenium oxide particles and/or activated carbon particles and possibly further conductivity-enhancing additives suspended in an electrolyte. In some embodiments, this cathode material may be spread over the cathode current collector. In some embodiments, this cathode material may be coated over the cathode current collector. The cathode current collector may take the form of a thin, conductive sheet or thin, conductive mesh.

Some embodiments involve an electrochemical energy cell that has at least one battery cell including: an anode electrode unit; a cathode electrode unit; and a first electrolyte body sandwiched between the anode and cathode electrode units; in which the first electrolyte body may be permeating a separator material; in which the cathode electrode unit includes a cathode material having a powder mixture of a powder of hydrated ruthenium oxide (chemical formula RuO₂.xH₂O) with activated carbon (AC, chemical formula C) particles and possibly conductivity-enhancing additives suspended in a second electrolyte body. A variety of carbon additives can be used in the battery on the RuO₂.xH₂O side, such as activated carbon, carbon nanotubes, graphene, carbon nanofoam, and carbon fiber, carbon black.

Some embodiments involve an electrochemical energy cell that has the anode electrode unit placed in a pocket made of a separator unit, which itself is imbued with an electrolyte body, and all of this wrapped in a cathode electrode unit, in which the cathode electrode unit includes a cathode material having a powder mixture of a powder of hydrated ruthenium oxide (RuO₂.xH₂O) with activated carbon (AC) particles and possibly conductivity-enhancing additives suspended in a second electrolyte body. Such embodiments are said to be constructed with the pocket method with the anode inside.

Some embodiments involve an electrochemical energy cell that has the cathode electrode unit placed in a pocket made of a separator unit, which itself is imbued with an electrolyte body, and all of this wrapped in an anode electrode unit, in which the cathode electrode unit includes a cathode material having a powder mixture of a powder of hydrated ruthenium oxide (RuO₂.xH₂O) with activated carbon (AC) particles and possibly conductivity-enhancing additives suspended in a second electrolyte body. Such embodiments are said to be constructed with the pocket method with the cathode inside.

Some embodiments involve an electrochemical energy cell that has an anode electrode unit; a cathode electrode unit; and a first electrolyte body sandwiched between the anode and cathode electrode units, and the full ensemble is folded in two, three, four or more folds, in order to reduce the outer physical surface area of the cell while keeping the effective cathode and anode active areas internal to the cell the same, in which the cathode electrode unit includes a cathode material having a powder mixture of a powder of hydrated ruthenium oxide (RuO₂.xH₂O) with activated carbon (AC) particles and possibly conductivity-enhancing additives suspended in a second electrolyte body. Some of these structures, for example, may resemble an accordion-fold type design.

Some aspects of some embodiments may involve a thin flexible battery with high capacity that can have a maximized active surface for efficient electrochemical reactions in the cell, which can be attained by using a powdered mixture of hydrated ruthenium oxide particles and activated carbon particles or other types of carbon additives suspended in an electrolyte.

Some aspects of some embodiments may involve the use of one or more additives to the cathode material or to the electrolyte to enhance conductivity and facilitate the chemical reactions that form the basis of the cathode action, or to prevent chemical reactions that are harmful to the cathode action. Some aspects of some embodiments may involve the use of one or more additives in the electrolyte to enhance the ionic conductivity of the electrolyte. Some aspects of some embodiments may involve the use of one or more additives in the electrolyte to prevent the formation of unwanted parasitic structures with use which degrade the performance and capacity of the battery. For example, one such parasitic structure may be dendrite formation, which may degrade battery performance in terms of the number of charge/discharge cycles in a rechargeable embodiment. Some aspects of some embodiments may involve the use of one or more additives in the electrolyte or on the anode structure to enhance conductivity and facilitate the chemical reactions that form the basis of the anode action, or to prevent chemical reactions that are harmful to the anode action. Some aspects of some embodiments may involve the use of one or more additives to the cathode material, anode material, or the electrolyte to improve the rechargeability performance of the battery.

Some aspects of some embodiments may involve an electrochemical energy cell that may include at least one rechargeable or one primary thin flexible battery unit, which can have any number of the flexible thin battery cells stacked on each other or included in the same physical packaging by another arrangement, and connected in series or parallel. The connections in such a stack or combination may be internal or external to the packaging.

Some embodiments of the thin anode electrode unit can include a layer of an oxidizable metal, such as zinc, aluminum, lead, tin, or combinations thereof, for example. The oxidizable metal can be either a sheet of the oxidizable metal or may include a sputter-coated metal powder on a flexible backing material. Some embodiments of the thin anode electrode unit can be constructed from a powder of an oxidizable metal, such as zinc or tin, or their mixtures, formed into a paste or suspended in an electrolyte and either spread or coated over an anode current collector, which can be a sheet, mesh, wire, or rod structure. The coating technique may be sputtercoating, thermal spray deposition, airbrushing, ink-jetting, aerosol-based coating, screen-printing, gravure printing, reverse gravure printing, or any other coating, painting or printing technique. Some embodiments of the thin anode electrode unit can be constructed by pressing the powder of an oxidizable metal, plus optional additive(s), into a slab or patty under high pressure exceeding 10000 psi.

Some embodiments of the cathode electrode unit can include a cathode material having a powder mixture of a powder of hydrated ruthenium oxide particles with activated carbon particles mixed in a volumetric ratio. The powder mixture may be suspended in an electrolyte body to form a paste to be spread over a cathode current collector, which can be a sheet, mesh, wire or rod structure. The powder mixture may also be coated over the aforementioned cathode current collector. The coating method may involve a technique based on Langmuir-Blodgett coating, airbrushing, aerosol-coating, painting, gravure printing, reverse gravure printing, ink-jetting, screen-printing, or any other coating, painting or printing technique that would serve. The powder mixture may vary over a wide range of volume ratios between the powder of hydrated ruthenium oxide and the powder of activated carbon, or (an)other conductivity-enhancing additive(s), depending on the individual application. In some embodiments, the volume ratio of the powder of RuO₂.xH₂O and powder of, for instance, AC in said powder mixture can vary in a range from 0%:100% volume ratio to 100%:0% volume ratio. In some embodiments, the volume ratio can be approximately 50%:50%.

A range of a thickness of the rechargeable electrochemical energy cell can be 1 cm or less. If the aforementioned pocket or folded designs are used, a range of a thickness of the rechargeable or primary electrochemical energy cell can be 1 cm or less per each fold or pocket face. Some embodiments may be 1 mm or less per each fold, or even 100 μm or less per each fold.

Some embodiments of the electrolyte body in contact with both the anode electrode and the cathode electrode unit, as well as the electrolyte body in which the powder mixture for the cathode and/or anode materials may be suspended, may include materials from a group of materials, in which some embodiments may include water, ethylene glycol, propylene glycol, glycerol, boric acid, citric acid, hydrochloric acid, sulfuric acid, acetic acid, perchloric acid, orthophosphoric acid, or other weak or strong acids, zinc chloride, sodium chloride, sodium phosphate, sodium citrate, zinc acetate, zinc perchlorate, ammonium chloride, ammonium sulfate and other salts, tetramethylammonium chloride, and other tetraalkylammonium salts, or sodium hydroxide, potassium hydroxide, or other bases, as well as further electrolyte additives to enhance conductivity, or to assist processes beneficial to the battery operation, or to prevent processes harmful to the battery operation.

Some embodiments of the electrolyte may include additives. In some embodiments, these additives may be differing amounts of sodium chloride, indium oxide, iridium oxide, sodium citrate, sodium phosphate, potassium phosphate, zinc oxide, Nafion™, agar, sugar, or other additives.

Some embodiments may include a permeable electrically insulating separator layer saturated with the electrolyte, and sandwiched between the anode and cathode electrode units contiguous to the cathode material on one side and to the anode material on the other. The separator layer can be a material that is porous to ions in liquid and is electrically non-conductive, i.e. an ionic conductor and electronic insulator material. The separator layer may be formed from a number of materials, including glass fiber filter paper, cleanroom-grade tissue paper, styrene-grafted fluorinated ethylene polypropylene, Celgard™ separator, AMC™ separator, a sheet of gelatin or other gelled material prepared with water, or glycerol, or one of the electrolyte liquids described above, or other materials that may serve the same purpose, e.g., other commercial separators, glass beads of various sizes (ranging from tens of nanometers to tens of microns or more), Nafion™ or other ionically-conductive membranes.

Some embodiments of the structure may include a flexible backing layer of conductive graphite, which backs the cathode material spread thereon in a predetermined active area. This layer may serve as a cathode current collector as well as mechanical support and backing for the cathode material. The surface of the graphite foil may have corrugations, serrations, grooves, holes, etc., to further expand and maximize the active area of the electrochemical cell. Some embodiments of the structure may replace the conductive graphite backing layer with a layer of carbon cloth, mesh, carbon nanofoam, carbon-based inks coated on a variety of substrates, or carbon additives, with the cathode material pressed into the mesh holes where present and spread over the active area. Some embodiments of the structure may replace the conductive graphite backing layer (or other forms of carbon) with a layer of metal (e.g., copper, aluminum, gold or any other metal) mesh or foil (or nanotubes, nanowires, foam, porous metal, or a sheet) coated with an electrically conductive, chemically non-reactive polymer such as polyaniline or polypyrrole, with the cathode material being spread over the active area and pressed into the mesh holes where these holes are present in the cathode current collector. Some embodiments of the structure may replace the conductive graphite backing layer with a layer of metal foil coated with an electrically conductive, chemically non-reactive (or non-soluble in the electrolyte being used) polymer such as described above. Some embodiments of the structure may replace the conductive graphite backing layer with a layer of Mylar (or other plastic material), or other non-electrically conductive materials including cloth fibers, plastics, semiconductors, in any form (such as mesh, foil, or rod) coated with an electrically conductive, chemically non-reactive polymer such as described above. All these variants of this structure may act as a cathode current collector.

Some aspects of some embodiments may involve a method of fabricating a flexible, thin, rechargeable or primary electrochemical cell. The method may involve forming a graphite backing layer of predetermined dimensions from a flexible graphite foil (e.g., corrugations may be applied on the surface of the graphite foil), identifying a predetermined active area on a respective surface of the graphite layer, and mixing a powder mixture from a predetermined quantity of a powder of hydrated ruthenium oxide and a powder of activated carbon. The method may involve, for example, preparing a paste from the powder mixture and an electrolyte, depositing the paste onto the active area on the backing graphite layer, thereby forming a cathode electrode unit. In this case, the graphite backing layer is acting as a current collector. The method may involve forming a metal anode electrode unit, forming a separator layer of predetermined dimensions from a permeable electrically insulating material, positioning the separator layer on the cathode electrode unit contiguous to the paste dispersed on the active area, impregnating the separator layer with the electrolyte, and attaching the metal anode electrode unit to the cathode electrode unit with the separator layer sandwiched between.

Some aspects of some embodiments may involve a method of fabricating a flexible, thin, rechargeable or primary electrochemical cell. The method may involve forming a backing layer of predetermined dimensions from a flexible graphite mesh or carbon cloth, identifying a predetermined active area on a respective surface of the graphite mesh, and mixing a powder mixture from a predetermined quantity of a powder of hydrated ruthenium oxide and a powder of activated carbon. The method may involve preparing a paste from the powder mixture and an electrolyte, depositing the paste on the active area on the backing graphite mesh and pressing it into the space between the threads of the mesh, thereby forming a cathode electrode unit. In this case, for example, the mesh or cloth is acting as a current collector. The method may involve forming a metal anode electrode unit. This metal anode electrode layer may be formed from a flexible thin sheet or foil of an oxidizable metal, or from a flexible thin mesh of an oxidizable metal. The method may involve forming a separator layer of predetermined dimensions from a permeable electrically insulating material, positioning the separator layer on the cathode electrode unit contiguous to the paste dispersed on the active area, impregnating the separator layer with the electrolyte, and attaching the metal anode electrode unit to the cathode electrode unit with the separator layer sandwiched between.

Some aspects of some embodiments may involve a method of fabricating a flexible, thin, rechargeable or primary electrochemical cell. The method may involve forming a backing layer of predetermined dimensions from a flexible, thin metal or Mylar (or other similar) plastic mesh or foil coated with an electrically conductive, chemically inert polymer such as polyaniline or polypyrrole, identifying a predetermined active area on a respective surface of the mesh or foil, and mixing a powder mixture from a predetermined quantity of a powder of hydrated ruthenium oxide and a powder of activated carbon. The method may involve preparing a paste from the powder mixture and an electrolyte, depositing the paste on the active area on the backing mesh and pressing it into the space between the threads of the mesh, or spreading the paste on the active area on the backing foil, thereby forming a cathode electrode unit. In this case, the backing mesh or foil is acting as a current collector. The method may involve forming a metal anode electrode unit. The method may involve forming a separator layer of predetermined dimensions from a permeable electrically insulating material, positioning the separator layer on the cathode electrode unit contiguous to the paste dispersed on the active area, impregnating the separator layer with the electrolyte, and attaching the metal anode electrode unit to the cathode electrode unit with the separator layer sandwiched therebetween.

Some aspects of some embodiments may involve a method of fabricating a flexible, thin, rechargeable or primary electrochemical cell. This method may proceed as above, but utilizing a cathode electrode unit constructed by coating a thin chemically inactive material with a cathode material formed of nanoparticles as described above. This coating technique may be Langmuir-Blodgett-based coating, screen-printing, inkjet printing, aerosol-based printing, airbrushing, thermal spray deposition, gravure coating, reverse gravure coating, or any other technique that would serve. The method may involve forming a metal anode electrode unit. The method may involve forming a separator layer of predetermined dimensions from a permeable electrically insulating material, positioning the separator layer on the cathode electrode unit contiguous to the paste dispersed on the active area, impregnating the separator layer with the electrolyte, and attaching the metal anode electrode unit to the cathode electrode unit with the separator layer sandwiched between.

Some aspects of some embodiments may involve a method of fabricating a flexible, thin, rechargeable or primary electrochemical cell. This method may proceed as described above for the preparation of the cathode electrode unit, with the use of any of the methods and cathode current collectors described, and for the preparations of the separator and the electrolyte. The method may involve the preparation of an anode electrode unit with the use of an anode current collector and an anode material. The anode current collector may be formed from a thin flexible layer of metal coated by an electrically conductive, chemically insulating polymer such as polypyrrole or polyaniline. In other embodiments, the anode current collector may be formed from a thin, flexible layer or sheet of Mylar, or other plastic material, coated by an electrically conductive, chemically inert polymer such as polypyrrole or polyaniline. In other embodiments, the anode current collector may be formed from a thin, flexible mesh of metal coated by an electrically conductive, chemically inert polymer such as polypyrrole or polyaniline, or of a thin flexible layer of such a polymer by itself. The method may involve the preparation of the anode material from a powder of an oxidizable metallic material such as zinc or aluminum, with the possible inclusion of additives to increase conductivity and improve paste formation. A paste may be prepared from this powder mixture and the electrolyte, and spread onto the anode current collector to prepare the anode electrode unit. In other embodiments, the powder mixture may be pressed, under high pressure (exceeding 10000 psi), into a thin slab or patty, which may be placed on a backing to form the anode electrode unit, or serve as the entire anode electrode unit by itself. In other embodiments, a layer of oxidizable metal serving as the anode material may be coated over an anode current collector, chosen from the described options above, by using sputter coating, thermal spray coating, airbrushing, aerosol-based coating, or any other coating, painting or printing technique that would serve. In other embodiments, the anode current collector and anode material may be one and the same structure, a thin flexible foil or mesh formed from the anode metal, forming the anode electrode unit by itself. The battery assembly may be concluded with the placement of the separator layer between the cathode electrode unit and the anode electrode unit.

Some aspects of some embodiments may involve a first contact strip attached between the bottom of the cathode current collector and the bottom seal layer, with an end of the first contact strip extending beyond an edge thereof. A second contact strip can be attached between a top seal layer and the metal anode electrode layer, or the anode current collector when the appropriate assembly method is used, with an end of the second contact strip extending beyond an edge of the top seal layer. The top and bottom seal layers can be adhered each to the other, using chemical, thermal or mechanical adhesion techniques, laser-welding, ultrasonic welding, or a combination of these methods at the perimeter of the cell, thus forming a sealing package enveloping the cell.

Some aspects of some embodiments that are constructed using either of the pocket methods described above may involve a contact strip being attached to the electrode unit that is placed inside the pocket and reaching outwards through the mouth of the packet. The second contact may be formed by directly contacting the electrode unit that forms the outside of the pocket. The edges of the outside pocket electrode may be sealed to each other, and a seal may be formed at the opening or mouth of the pocket in an electrically insulating manner to separate the contact strip from the inside electrode from the outside electrode, thereby forming a sealed package enveloping the cell.

For some embodiments, the electrochemical cell is configured for a reduction-oxidation (redox) reaction to generate power at the electrolyte/electrode interface surface of one or both of the electrode layers.

In some embodiments, the electrochemical cell may be less than 1 mm in thickness, and weigh less than 5 grams. The electrode body may be weakly or strongly acidic. The electrode body may be weakly or strongly basic. Some embodiments may involve electrochemical energy cells that are environmentally safe, thin, and with a charge voltage at 1.5 V or below in case they are designed and operated as rechargeable batteries.

One or more of the embodiments described herein may include the following features.
Cathode variations (e.g., different current collectors, cathode material as a coating, or as a paste, etc.)
Anode variations (e.g., different current collectors, mesh, coated materials, pressed materials)
Electrolyte variations (e.g., different solvent and solute chemistries)
Separator variations (e.g., filter paper, commercial separator, a gelled combination electrolyte/separator, glass beads)
Additives (e.g., Nafion™, salts, oxides)
Packaging variations (e.g., heat sealing, glue, epoxy)
Structure variations (e.g., pockets, folded)
A carbon-based material to be used in various structures to have a high surface area per unit volume with little electrical resistance as the cathode or anode current collector. Graphite foil can serve this purpose, in which it is flat (e.g., planar) and may be at least 75 microns thick, for example. This foil may represent the bulk of the thickness of a thin film cell in some embodiments. Putting grooves or other structures on the foil can increase the surface area. Other approaches to increase surface area involve having a thin substrate. Carbon nanotubes can be grown out of the surface of the graphite foil or a different substrate in order to increase surface area, thin carbon nanofoam can be used which inherently has a high surface area, or carbon-nanotube “paper”, sometimes referred to as “buckypaper” can be used.
An insulating substrate can be used that is very thin to serve as the basis for the anode or cathode current collector. The insulating material can be coated with a conductor that does not chemically react in the cell. Conductive “inks” of carbon can be viable for the coating (e.g., graphene and CNT inks), and conductive polymers can be used as alternatives (e.g., polyaniline and polypyrrole). By using an insulating substrate with an appropriate thickness for a desired internal resistance, there can be no risk of the conductive layer being eaten away to a metallic substrate.
A metallic substrate can be used that is very thin (e.g., Al foil), and a thin coat can be applied as described above.
Porous RuO₂.xH₂O can be used for a high surface area RuO₂.xH₂O. The porous RuO₂.xH₂O can be fabricated in a variety of techniques (e.g., by mixing with a second medium, such as salt or a cellulose type material) into a composite nanoparticle, then the salt can be dissolved away, or the cellulose type material can be burned away. In some embodiments, for example, the porous RuO₂.xH₂O can be processed at different temperatures, where the materials can be aggregated to form solids, then some materials can be dissolved away by taking advantage of different dissolution points (e.g., for salt) or different burning points (e.g., cellulose).

Some aspects of some embodiments may involve a flexible (e.g., bendable, twistable), rechargeable or primary battery, or electrochemical cell. The electrochemical cell can be bendable and twistable to form a non-planar shape. This battery may be integrated in a flexible electronics matrix. It may be applicable for powering devices which are distributed network nodes, or medical devices, or other portable or personal electronics devices, or miniature electronic devices. In some embodiments, potential applications can be used as “skin” for prosthetics, or as aircraft fuselage or wing “skin”, or as a tent lining, for example.

Some aspects of some embodiments may include a rechargeable or primary, flexible electrochemical cell that can have a simple manufacturing process and can be highly efficient in operation.

In some embodiments, an electrochemical energy cell can have at least one galvanic cell including:
an anode electrode unit,
a cathode electrode unit,
an electrolyte body between and contacting both said electrode units, and
a permeable, electrically insulating separator layer saturated with or including the said electrolyte body and placed within the cell in such a manner to contact both the anode and cathode electrode units so as to bring them in contact with the electrolyte body.

The cathode electrode unit can include a cathode material comprising a powder mixture of a powder of hydrated ruthenium oxide and one or more additives to increase conductivity and/or to enhance chemical and electrochemical reactions beneficial to the battery action or to suppress reactions harmful to the battery action, suspended in the electrolyte body and spread over a cathode current collector structure. The cathode unit can (alternatively) have a coating of the cathode material on an electrically conductive, chemically inert thin material acting as the cathode current collector. The anode electrode unit can include a structure formed of an oxidizable metal, optionally with additives to increase conductivity and/or to enhance chemical or electrochemical reactions beneficial to the battery action or to suppress reactions harmful to the battery action, where this structure may comprise the entire anode electrode unit by itself or the anode electrode unit may be constructed from an anode current collector and some form of the oxidizable metal as the anode active material in electrical contact. The separator layer can include a material that is porous to ions in liquid and is electrically non-conductive,

In some of these embodiments of the electrochemical energy cell the separator layer includes a glass fiber filter paper, cleanroom-grade tissue paper, styrene-grafted fluorinated ethylene propylene, a type of commercially-available separator or membrane materials such as Celgard™ or AMC™, a thin layer of gelled material prepared with glycerol or any other gelling and thickening agent such as agar, carboxymethyl cellulose, pectin, carrageenan, or a photo-polymerized acrylic hydrogel, or any other thin structure that may be formed to meet the qualifications of the cell. The separator layer can be treated with a surfactant or other methods to enhance the properties of the cell and to prevent battery performance degradation by way of dendrite formation. The separator layer includes a gel made with a gelling agent and electrolyte additives using one electrolyte variant or another liquid so as to yield an ionically conductive, electrically insulating gel. This option may embody the electrolyte body in with the gel separator body as well, although extra electrolyte can still be used. The materials used to construct the electrolyte variants and obtain a gel from the electrolyte liquid are referred to herein. The aforementioned additives can increase conductivity on either the cathode or anode side and may be particles of activated carbon, carbon nanotubes, graphene, other carbon-based particles, or of a commercially available battery additive. For the cathode-side conductivity-enhancing additives, the volume ratio of conductive additive to hydrated ruthenium oxide in the cathode material can vary between 0%:100% to 100%:0%. The cathode-side conductivity-enhancing additives may include non-oxidizing metals, such as gold, and the anode-side conductivity-enhancing additives may also include gold, aluminum, nickel, tin, and other oxidizing or non-oxidizing metals. The volume ratio of conductivity-enhancing additive to hydrated ruthenium oxide in the cathode material can be 50%:50%. The aforementioned additives to the cathode material to enhance chemical and electrochemical reactions can be beneficial to battery action or to suppress reactions harmful to battery action and may be agar, sucrose, sorbitol, platinum, palladium, iridium oxide, indium oxide, magnetite, Nafion™, metal-functionalized carbon nanotubes (e.g. nickel-plated carbon nanotubes), titanium dioxide, tungsten carbide, sodium chloride or other materials, and low-molecular weight or high-molecular weight polyethylene glycols. The amount of Nafion™ included may vary between 1 mL/cm² of active area to 5 mL/cm² of active area, and the composition of Nafion™ in solution may vary between 0.05% to 4% by volume. The aforementioned additives to the anode material to enhance chemical and electrochemical reactions beneficial to battery action or to suppress reactions harmful to battery action can be indium oxide, iridium oxide, zinc oxide, polyaniline, polypyrrole, crystalline boric acid, citric acid, acetic acid or other anhydrous acid materials, various surfactants such as sodium dodecyl sulfate, dodecyltrimethylammonium chloride or bromide, or polyethylene glycol, or other materials.

In some embodiments of the electrochemical energy cell, the cathode or anode current collector structure may include the following:
a thin layer of graphite foil, a graphite mesh, carbon cloth, carbon nanofoam, or any flexible material coated with carbon-based inks or carbon-based additives, or
a thin copper or aluminum or any other metal mesh or foil, coated with an electrically conducting, electrically insulating polymer such as polypyrrole or polyaniline, or
a thin Mylar or another type of plastic foil coated with the same, or
any flexible material coated with the same.

The cathode or anode current collector structure may be in any form factor including sheet (planar), block, rod, etc. The surface of the cathode or anode current collector may be modified to obtain corrugations, serrations, grooves, or holes to expand and maximize the active surface area of the battery by expanding the contact area between the anode/cathode current collectors and the anode/cathode active materials.

In some embodiments of the electrochemical energy cell, the cathode unit is made of the following:
a cathode current collector and a paste of the cathode active material and optional additives suspended in electrolyte being spread on the cathode current collector, or
a cathode current collector and a paste of the cathode active material and optional additives being suspended in electrolyte being pressed through the mesh holes of the cathode current collector in case a mesh-type structure has been used to form the cathode current collector, or
a coating of the cathode active material on the cathode current collector may be obtained by using Langmuir-Blodgett-based coating, screen-printing, inkjet printing, aerosol-based printing, gravure coating, reverse gravure coating, or any other printing, deposition, painting or coating technique for this coating.

The coating may be multiple layers of coating, such as one or more layers of cathode active material mixed with additives, or one or more layers of cathode active material followed by one or more layers of cathode additives followed by one or more layers of cathode active material, or any conceivable combination of layer order and numbers. In some embodiments, each layer of coating may be less than 10 mil (250 μm) thick.

The cathode electrode unit can have a coating that is optionally treated by annealing the coating by the method of heating the coating to a temperature between 100° C. and 300° C. for a period of time between 0.5 hours and 3 hours, and/or the cathode electrode unit can have a coating that is top-coated with a thin layer of conductive additive prior to the electrochemical cell construction.

In some aspects of some embodiments, the electrochemical energy cell can have the electrolyte body to be acidic with a pH lower than 7, or the electrolyte body can be basic with a pH higher than 8. The electrolyte body can include materials from ethylene glycol, glycerol, propylene glycol, distilled (deionized) water, boric acid, citric acid, tartaric acid, acetic acid, other organic acids, hydrochloric acid, sulfuric acid, perchloric acid, nitric acid, orthophosphoric acid, boric acid, or other inorganic acids, zinc chloride, zinc nitrate, zinc acetate, zinc perchlorate, sodium chloride, ammonium sulfate, ammonium chloride, other metal salts, tetramethylammonium chloride, tetraethylammonium chloride, tetrabutylammonium chloride, or other quaternary ammonium salts, ammonium hydroxide, sodium hydroxide, potassium hydroxide or other bases, and other solvents, acids, bases and salts.

In some aspects of some embodiments, the electrolyte body includes additives from sodium chloride, potassium chloride, sodium citrate, sodium phosphate, potassium phosphate, zinc oxide, zinc citrate, sucrose or glucose, sorbitol, zinc oxide, indium oxide, iridium oxide, platinum, palladium, titanium dioxide, tungsten carbide, or metal-enhanced carbon nanotubes (such as nickel plated carbon nanotubes), polyethylene glycol, and other materials, and other additives. These additives may serve to increase the ionic conductivity of the electrolyte, and/or to enhance chemical or electrochemical reactions beneficial to the battery action, performance and energy generation, and/or to inhibit chemical or electrochemical reactions harmful to the battery action, performance and energy generation, or these additives can serve as surfactants to enhance the contact between the electrolyte body and the anode and cathode electrode units. These additives may also serve to prevent the formation of parasitic structures, such as dendrites, which may affect battery performance. The electrolyte body may include a gel made with a gelling agent (cellulose, methyl cellulose, hydroxyethyl cellulose, agar, pectin, gelatin, carboxymethyl cellulose, or other gelling agents and optional thickening agents and surfactants) and the electrolyte liquid formed as described above.

In some aspects of some embodiments, the anode electrode unit is a thin layer, sheet, foil or mesh of oxidizable metal, and the oxidizable metal may be chosen from zinc (Zn), aluminum (Al), tin (Sb) or lead (Pb), or another metal that will be able to supply electrons for the anode action. In some embodiments, the anode electrode unit is made from an anode current collector and a paste of an oxidizable metal and other additives suspended in electrolyte and spread on or pressed through the anode current collector, or the anode electrode unit is made from an anode current collector coated with an oxidizable metal and optional additives, where the coating is obtained by sputtercoating, thermal spray deposition, airbrushing, other aerosol-based methods, Langmuir-Blodgett-based coating, gravure or reverse gravure printing, inkjet printing, screen-printing, or any other coating, deposition, painting or printing methods that would serve for coating. The coating may be multiple layers of coating, for instance one or more layers of oxidizable metal mixed with additives or other metals, or one or more layers of oxidizable metal followed by one or more layers of anode additives or other metals followed by one or more layers of oxidizable metal, or any conceivable combination of layer order and numbers. Each layer of coating may be less than 10 mil (250 μm) thick. The anode electrode unit can be made from a slab or patty made by pressing a powder of an oxidizable metal and, optionally, additives, under high pressure exceeding 10000 psi.

In some aspects of some embodiments, the anode current collector can include the following:
a mesh of an oxidizable metal, or
a mesh of a metal coated with an electrically conductive, chemically isolating polymer such as polyaniline or polypyrrole, or
a thin foil of Mylar or other similar plastic material coated with electrically conducting, chemically isolating polymer such as polyaniline or polypyrrole, or
a thin layer of carbon cloth or graphite mesh.

The ratio of powder of oxidizable metal and additives may vary between 100%:0% and 0%:100%. The additives can be chosen from zinc oxide, agar, indium oxide, iridium oxide, sucrose, glucose, boric acid, other weak organic acids, polyaniline, polypyrrole, various surfactants, or other materials.

In some aspects of some embodiments, the electrochemical energy cell can include a positive lead structure (positive contact) and a negative lead structure (negative contact), allowing the transfer of electrical current into and out of the electrochemical energy cell, each electrically connected to one of the cathode electrode unit and anode electrode unit respectively.

In some aspects of some embodiments, the electrochemical energy cell can include a packaging/sealing structure chemically isolating the other battery parts from the ambient and electrically insulating the other battery parts, except the positive and negative lead contacts, from the ambient, for which the structure is formed of an electrically insulating and chemically isolating, thin and optionally flexible material such as Mylar or other types of plastic, which may or may not feature self-adhesive properties.

In some aspects of some embodiments, the isolation properties of the packaging structure can be generated by:
heat sealing, or
by chemical sealing, or
the use of commercial glues, adhesives or epoxies, or
the use of ultrasonic welding, or
by the use of laser welding, or
by the use of other mechanical sealing methods, such as clamping, or
a combination of these methods.

Some aspects of some embodiments, involve a method of manufacturing a thin flexible electrochemical energy cell that involves forming at least one battery by an anode-center pocket battery method. The anode electrode unit, cathode electrode unit(s), electrolyte body or bodies, and packaging comprise of any of the alternative structures described herein. The anode electrode unit can be placed in a pocket made of a separator unit that is imbued with an electrolyte body and wrapped in a cathode electrode unit, or covered on both sides by a gel-type separator and wrapped in a cathode electrode unit.

Some aspects of some embodiments involve a method of manufacturing a thin flexible rechargeable electrochemical energy cell, where the method involves forming at least one battery by a cathode-center pocket battery method. For this method, the cathode electrode unit, anode electrode unit(s), electrolyte body or bodies, and packaging can be of any of the alternative structures described herein. The cathode electrode unit is placed in a pocket made of a separator unit that is imbued with an electrolyte body and wrapped in an anode electrode unit, or covered on both sides by a gel-type separator and wrapped in an anode electrode unit.

Some aspects of some embodiments relate to an electrochemical energy cell that has an anode electrode unit, a cathode electrode unit and a first electrolyte body sandwiched between the anode and cathode electrode units. The cell can be folded in two, three, four or more folds to reduce a physical surface area of the cell while keeping an effective active area the same, where the cathode electrode unit can include a cathode material having a powder mixture of a powder of hydrated ruthenium oxide (RuO₂.xH₂O) with activated carbon (AC) particles. The cell can resemble an accordion-fold type design.

Some aspects of some embodiments describe a method of manufacturing the electrochemical energy cell, comprising forming at least one battery by a pocket or folded battery method, where the cathode electrode unit(s), anode electrode unit(s), electrolyte body or bodies, and packaging can be any of the alternative structures described herein.

If pocket or folded designs are implemented in a structure of the battery, for example, a range of the thickness of the electrochemical energy cell can be the following:
1 cm or less per each fold or pocket face, or
1 mm or less per each fold or pocket face, or
100 μm (e.g., 0.1 mm) or less per each fold or pocket face.

In some aspects of some embodiments, an electrochemical energy cell includes the following:
a cathode material including a powdery mixture of hydrated ruthenium oxide particles and activated carbon particles, and, optionally, conductivity-enhancing or performance-enhancing additives suspended together in an electrolyte, and a cathode current collector, comprising a conductive sheet or a conductive mesh or foil or rod or the types described above, upon which the cathode material is spread, and pressed into the holes of the mesh if a mesh-type structure has been used for the cathode current collector.
a cathode material that includes a powdery mixture of hydrated ruthenium oxide particles and activated carbon particles, and, optionally, conductivity-enhancing or performance-enhancing additives coated upon or mixed with the powdery mixture; and a cathode current collector that includes a conductive sheet or a conductive mesh or foil or rod or the types described above, upon which the cathode material is coated.
at least one battery cell including:
   an anode electrode unit;
   a cathode electrode unit; and
   a first electrolyte body sandwiched between the anode and cathode electrode units;
      The first electrolyte body permeates a separator material. The cathode electrode unit includes a cathode material having a powder mixture of a powder of hydrated ruthenium oxide (RuO₂.xH₂O) with activated carbon (AC) particles, or the cathode electrode unit includes a cathode material having a powder mixture of a powder of hydrated ruthenium oxide (RuO₂.xH₂O) with other conductivity-enhancing additives listed herein.
      The cathode material is mixed with conductivity-enhancing additives suspended in a second electrolyte body, where this cathode material is deposited on or coated upon a cathode current collector, and where such additives include activated carbon, carbon nanotubes, graphene, carbon nanofoam, and carbon fiber.

In some aspects of some embodiments, the electrochemical energy cell can include a thin, flexible battery with a high capacity that has an active surface for electrochemical reactions in the cell, where the high capacity is attained by maximizing the active surface area by means of using, for instance, a powdered mixture of hydrated ruthenium oxide particles and activated carbon particles, or other additives described herein, suspended in an electrolyte, and the particles of RuO₂.xH₂O and activated carbon (or other conductivity-enhancing additive) may have been pre-processed to obtain particles with higher porosity and surface area per unit weight.

In some aspects of some embodiments, the embodiments can involve at least one thin flexible battery unit, and any number of the flexible thin battery cells stacked on each other within a single package or packaged individually, or combined in another geometric arrangement within a single package, and connected in series or parallel, with the connections being formed either within the packaging, or outside the packaging, or a combination of both approaches. In some embodiments of the electrochemical energy cell, the thin anode electrode unit includes:
a layer of an oxidizable metal including zinc, aluminum, tin, or lead or other metals with appropriate electrochemical properties and the ability to give electrons to the outer circuit, where the oxidizable metal include a sheet or foil of this oxidizable metal, or
a sputtercoated or thermally coated metal powder layer on a flexible conductive backing material, or a metal powder layer coated with any appropriate coating method on a flexible conductive backing material, or
metal powder compressed into a slab or patty with the application of high pressure, or
a powder of the oxidizable metal and optional additives, such as those described herein, formed into a paste with the addition of a small amount of electrolyte and suspended over or spread over an anode current collector that comprises a sheet or a mesh structure, or any other structure as described herein.

In some aspects of some embodiments, the electrochemical energy cell, the cathode electrode unit includes a cathode material containing a powder mixture of hydrated ruthenium oxide particles and activated carbon particles (or another conductivity-enhancing material, as described herein), mixed in a volumetric relationship, where the powder mixture is suspended in an electrolyte body to form a paste, and where the powder mixture is variable over a range of volume ratios between the powder of hydrated ruthenium oxide and the powder of activated carbon. In some embodiments, the volume ratio of the powder of RuO₂.xH₂O and powder of activated carbon in the powder mixture is variable in a range from 0%:100% volume ratio to 100%:0% volume ratio. In some embodiments, one electrolyte body is in contact with the anode electrode unit, the cathode electrode unit, and another electrolyte body in which the powder mixture is suspended, in which the electrolyte bodies include the following:
one or more solvents ranging from water to aqueous-organic mixtures, including one or more of the followings: ethylene glycol, propylene glycol, glycerol, or low molecular mass polyethylene glycol, and a weak acid, such as boric acid, citric acid, tartaric acid, or acetic acid, and/or a strong acid, such as hydrochloric acid, sulfuric acid, nitric acid, perchloric acid, or orthophosphoric acid, and
a salt mixture, including one or more of the following: zinc chloride, zinc acetate, zinc perchlorate, zinc nitrate, zinc citrate, ammonium chloride, ammonium nitrate, ammonium acetate, ammonium sulfate, sodium chloride, sodium perchlorate, potassium chloride, or sodium citrate, or a base, such as ammonium hydroxide.

The solution in the electrochemical energy cell can include:
a mixture of approximately 34-48% (by volume) of ethylene glycol or propylene glycol or their mixture, 31-38% boric acid, 12-18% citric acid and 0.5-1.2 mL ammonium hydroxide per 100 mL of electrolyte solution, or
a mixture of 39-45% (by volume) of glycerol, 25-39% boric acid, 7-21% citric acid, and 1-2% sodium chloride, or
a mixture of 9-13% (by volume) of citric acid and 7-11% ethylene glycol, or
a mixture of 23.5-30.5% (by volume) of citric acid and/or 69.5-86.5% glycerol, or
a mixture of 25% aqueous solution of concentrated hydrochloric acid (36.5-38.0% by mass), 30-35% ethylene glycol, 24-27% boric acid, and 13-16% citric acid, or
a mixture of 6.5-9.5% by mass citric acid, 16.2-18.6% by mass sodium citrate, which forms a buffer, and 3-5% by volume of aqueous hydrochloric acid (36.5-38% by mass), or
a mixture of 7.8-12.5% (by mass) zinc chloride and 9.215.2% ammonium chloride (by mass) in de-ionized water and 1.5-3.2 mL hydrochloric acid added to 100.mL solution, or
a mixture of 7.5-22.5% (by mass) zinc acetate and 8.9-14.6% ammonium chloride (by mass) in de-ionized water and 0.5-2.1 mL hydrochloric acid or 2.2-3.4 mL glacial acetic acid added to 100 mL solution, or
a mixture of 8.8-25.9% (by mass) zinc acetate and 6.2-9.2% ammonium sulfate (by mass) in de-ionized water and 0.5-1.2 mL sulfuric or 3-6 mL orthophosphoric acid added to 100 mL solution, or
a mixture of 5.3-8.2% (by mass) zinc perchlorate and 4.2-8.4% ammonium sulfate (by mass) or 8.8-12.2% (by mass) in de-ionized water and 0.2-0.8 mL sulfuric acid or 0.5-0.6 mL perchloric acid or 1.6-2.8 mL orthophosphoric acid or 2.5-4.5 mL glacial acetic acid added to 100 mL solution.

In the solution, the “boric acid” may be prepared by dissolving 5 g or less of boric acid crystals in 100 mL of water, the “citric acid” may be prepared by dissolving 50 g or less of citric acid crystals in 100 mL of water, with drops of added hydrochloric acid to adjust acidity (optional), or other compositions. In the electrochemical energy cell, the electrolyte can include additives with differing amounts of sodium chloride, indium oxide, iridium oxide, sodium citrate, sodium phosphate, potassium phosphate, zinc oxide, Nafion™, agar, sucrose or glucose, polyethylene glycol (PEG 200, 400, 1000, 3350, or 6000), or other additives. Also, in the electrochemical energy cell, the solution can include a strong base and one or more salts, dissolved in de-ionized water, where examples include, but are not limited to the following:
18.4-22.8% (by mass) of sodium hydroxide in de-ionized water, or
16.8-24.4% (by mass) of sodium hydroxide and 6.8-10.2% (by mass) of zinc chloride in de-ionized water, or
22.6-30.2% (by mass) of potassium hydroxide in de-ionized water, or
20.4-28.5% (by mass) of sodium hydroxide and 5.4-9.6% (by mass) of zinc chloride in de-ionized water.
   In the electrochemical energy cell, the solution can include one or more quaternary ammonium salts, dissolved in an organic solvent or in an aqueous-organic solvent mixture, where examples include, but are not limited to the following:
20.4-25.8% (by mass) of tetramethylammonium chloride in ethylene glycol or propylene glycol, or
19.4-25.8% (by mass) of tetraethylammonium chloride in ethylene glycol or propylene glycol or in the 1:1 (by volume) mixture of ethylene glycol and propylene glycol, or
32.4-42.6% (by mass) of tetrabutylammonium chloride in ethylene glycol or glycerin, or
12.4-16.2% (by mass) of tetramethylammonium chloride and 10.5-14.5% (by mass) tetraethylammonium chloride in ethylene glycol or propylene glycol or in the 2:1 (by volume) mixture of ethylene glycol and propylene glycol, or
5.4-9.1% (by mass) of tetramethylammonium chloride and 4.3-6.8% (by mass) tetraethylammonium chloride and 9.8-12.4% (by mass) of tetrabutylammonium chloride in ethylene glycol, or
18.2-23.5% (by mass) of tetramethylammonium chloride in 85-90% (by volume) ethylene glycol and 10-15% (by volume) of de-ionized water, or
18.2-23.5% (by mass) of tetraethylammonium chloride in 80-89% (by volume) ethylene glycol and 11-20% (by volume) of de-ionized water, or
28.6-39.2% (by mass) of tetrabutylammonium chloride in 88-92% (by volume) ethylene glycol and 8-12% (by volume) of de-ionized water.
   The electrochemical energy cell can also include a permeable electrically insulating separator layer saturated with the electrolyte and sandwiched between the anode and cathode electrode units contiguous to the cathode material on one side and to the anode material on the other, where the separator layer is an ionic conductor, e.g., a material that is permeable to the ions contained by the liquid, and is electrically non-conductive; the separator layer is formed of a material including glass fiber filter paper, cleanroom-grade tissue paper, styrene-grafted fluorinated ethylene polypropylene, Celgard™ separator, AMC™ separator, a sheet of gelatin prepared with water or glycerol, a sheet of gel prepared from other solvents including the electrolyte compositions described herein and other types of gelling agents, glass beads of various sizes, Nafion™ or other ionically-conductive membranes. The separator layer can include a body of gel, obtained by using a gelling agent such as cellulose, agar, carboxymethyl cellulose, methyl cellulose, hydroxyethyl cellulose, carrageenan, pectin, gelatin, or any other gelling agent, or a combination of these, an electrolyte body with or without additives, such as described herein, as the liquid basis, and optionally by the addition of thickening agents such as glycerol and surfactants such as polyethylene glycol, Triton™, or other materials that would serve such a purpose. The separator layer described herein can be a body of hydrogel, obtained by the photopolymerization of a mixture of acrylic polymers, including acrylonitrile and acrylic acid with an aqueous electrolyte solution incorporated in the polymer.

In some aspects of some embodiments, a method of fabricating a flexible thin electrochemical cell involves the following:
forming a backing layer of predetermined dimensions from the following:
   a flexible graphite foil, or
   a flexible graphite mesh, or carbon cloth, or
   a flexible, thin foil or mesh or sheet of metal or plastic coated with an electrically conductive, chemically isolating polymer such as polyaniline or polypyrrole, or
   a flexible, thin foil or mesh or sheet of metal or plastic coated with a carbon-based dye or paint or ink, or from any of the materials described herein for current collector structures;
identifying a predetermined active area on a respective surface of the backing layer;
mixing a powder mixture from a predetermined quantity of a powder of hydrated ruthenium oxide and a powder of activated carbon;
preparing a paste from the powder mixture and an electrolyte;
depositing the paste on the active area on the backing layer; and
in the case when a mesh-type structure has been used as a backing layer, pressing the paste into the space between the threads of the mesh; thereby forming a cathode electrode unit, for which the backing layer is configured to serve as a current collector;
forming an anode electrode unit by any method or combination of methods as described herein;
forming a separator layer of predetermined dimensions from a permeable electrically insulating material;
positioning the separator layer on the cathode electrode unit contiguous to the paste deposited or coating created on the active area;
impregnating the separator layer with the electrolyte; and
attaching the metal anode electrode unit to the cathode electrode unit with the separator layer sandwiched between.

In some aspects of some embodiments, a method involves fabricating a flexible thin electrochemical cell that utilizes a cathode electrode unit constructed by coating a thin, conductive, chemically inactive material with a cathode material formed of particles, where the coating includes Langmuir-Blodgett-based coating, screen printing, inkjet printing, aerosol-based printing, gravure coating, or reverse gravure coating. This method further involves:
forming an anode electrode unit by any method or combination of methods as described elsewhere in this disclosure;
forming a separator layer of predetermined dimensions from a permeable electrically insulating material;
positioning the separator layer on the cathode electrode unit contiguous to the paste dispersed on the active area;
impregnating the separator layer with the electrolyte; and
attaching the metal anode electrode unit to the cathode electrode unit with the separator layer sandwiched therebetween.

In some aspects of some embodiments, a method involves fabricating the anode electrode unit of a flexible thin electrochemical cell, the method involves the following:
preparing an anode electrode unit with the use of an anode current collector and an anode material, where the anode current collector is formed from the following:
   a thin flexible layer, foil, sheet or mesh of metal, plastic, or other material coated by an electrically conductive, chemically isolating polymer such as polypyrrole or polyaniline, or
   a thin flexible layer, foil, sheet or mesh of metal, plastic, or other material coated by carbon-based inks, or paints, or
   a thin flexible layer of an electrically conductive, chemically isolating polymer.
Preparing the anode material from a powder mixture of an oxidizable metallic material comprising zinc or aluminum, including additives to increase conductivity and improve paste formation, or
preparing the anode material from a sheet, foil or mesh of an oxidizable metallic material, or
preparing the anode material by pressing the powder of an oxidizable metallic material and additives into a slab or patty under high pressure, and
combining the anode material with the anode current collector by placing, coating, or attaching the anode material on the anode current collector as appropriate, such that electrical contact between the anode material and the anode current collector is insured.
   The method can also involve the following:
preparing a paste from the anode material powder mixture and the electrolyte, and spreading this onto the anode current collector to prepare an anode electrode unit, or
spreading this and pressing it between the threads of a mesh when a mesh-type structure has been used for the anode current collector, or
coating, depositing, or painting it over the anode current collector as appropriate, such that electrical contact between the anode material and the anode current collector is insured.
   In this method, the anode current collector and anode material may include the same structure, which may be a thin flexible foil or mesh is formed from an anode metal to thereby form the anode electrode unit, or a powder of oxidizable metal and anode additives pressed into a slab or foil or patty by applying pressure exceeding 10000 psi to thereby form the anode electrode unit.

Some aspects of some embodiments involve a method of fabricating an electrochemical energy cell, where the method involves placing a bottom seal layer on the surface of the cathode current collector facing outward, that is to say, the surface which is not in contact with the separator and the electrolyte body, such that the edges of the bottom seal layer extend beyond the cathode current collector edges and beyond the separator edges. The method involves placing a first contact strip attached between a bottom of a cathode current collector and a bottom seal layer, with an end of the first contact strip extending beyond an edge of the bottom seal layer thereof, or opening up a hole in the bottom seal layer somewhere over the cathode current collector surface and filling this hole with an electrically conductive material such as conductive epoxy, and attaching a contact strip to this material to form the positive contact. The method also involves placing a top seal layer on the surface of the anode current collector or metal anode electrode layer facing away from the separator and the electrode body, such that the edges of the top seal layer extend beyond the anode electrode unit edges and beyond the separator edges, or opening up a hole in the bottom seal layer somewhere over the anode electrode unit surface and filling this hole with an electrically conductive material such as conductive epoxy, and attaching a contact strip to this material to form the negative contact. The top and bottom seal layers are adhered each to the other at a perimeter of the cell, thus forming a sealing package enveloping the cell. In the case of a folded or pocket structure, the method involves using a contact strip attached to the electrode unit that is placed inside a pocket and reaching outwards through the mouth of the packet, where the second contact is formed by directly contacting the electrode unit that forms an outside of the pocket, and the edges of the outside pocket electrode are sealed to each other, and a seal is formed at the opening or mouth of the pocket in an electrically insulating manner to separate at least one of the contact strips from the inside of the electrode unit from the outside of the electrode unit, thereby forming the sealed package enveloping the cell. The electrochemical cell is bendable and twistable to form a non-planar shape.

In some aspects of some embodiments, the electrochemical energy cell is configured for a reduction-oxidation (redox) reaction to generate power at the interface(s) of one (or both) of the electrode layer(s) and the electrolyte body. The electrochemical cell can be less than 1 mm in thickness, and weighs less than 5 grams, and the cell can be environmentally safe and non-toxic. The cell thickness can be less than 1 mm per number of cathode/electrolyte surfaces present in its structure, and the cell weight can be less than 5 grams per number of cathode/electrolyte surfaces present in its structure.

In some aspects of some embodiments, the thin, flexible battery cell, or an electrochemical energy cell can be comprised of thin, flexible battery cells packaged together, which can be integrated into a flexible electronics system, device or matrix, and which may be the battery or electrochemical energy cell described herein. Some embodiments have a thin, flexible battery, applicable for powering distributed network node devices, or medical devices, or portable or personal electronics, and which may be the battery or electrochemical energy cell described herein. Some embodiments can have a thin battery or electrochemical cell which may be rechargeable and require a low charge voltage, in which the low voltage is below 1.5 volts, and which may be the battery or electrochemical energy cell described herein. In some embodiments, the electrochemical energy cell can have a high capacity where the charge capacity meets or exceeds 1 mAh/cm² of active area or where the charge capacity meets or exceeds 10 mAh/cm² of active area.

In some aspects of some embodiments, an electrochemical energy cell can include the following:
an anode electrode unit prepared with any of the methods described herein,
a cathode electrode unit prepared with any of the methods described herein,
an electrolyte body between and contacting both electrolyte units, prepared with any of the methods described herein,
an ion-permeable, electrically insulating separator prepared with any of the methods described herein,
a chemically isolating, and electrically insulating packaging structure prepared with any of the methods described herein,
negative and positive leads (contact structures) connected electrically to the anode and cathode electrode units, respectively, and reaching outside the packaging structure,
a final form factor of the electrochemical energy cell having a form factor other than planar form factor, such as a form factor that is bent, twisted, rolled into a cylinder, folded, or formed into a block, and
a property where the electrochemical energy cell may also be rechargeable and require a low charge voltage below 1.5 volts.

The electrolyte body has compositions for the electrochemical cell that may be configured with and for one or more properties, including the following properties:

a. it may be designed to enhance cell capacity, for instance by enabling higher rates and net amount of electron acceptance from the outside circuit by the hydrated ruthenium oxide active cathode material,

b. it may be designed to enhance cell cycle lifetime, for instance by enabling and enhancing the cathode reactions that are easily reversible,

c. it may be an aqueous solution comprising various salts, additives, and organic and inorganic acids as described elsewhere in this application,

d. it may be a solution of an organic solvent and various salts, additives, and organic and inorganic acids as described elsewhere in this application, and/or

e. it may be prepared in the form of a gel by the addition of gelling agents such as agar, carboxymethyl cellulose, or other gelling agents as mentioned elsewhere in this disclosure.

The descriptions above are intended to illustrate possible implementations and are not restrictive. Many variations, modifications and alternatives will become apparent. For example, method steps equivalent to those shown and described may be substituted therefore, elements and methods individually described may be combined, and methodologies described as discrete may be distributed across many algorithm techniques. While this disclosure contains many specifics, these should not be construed as limitations or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. The scope of the disclosure should therefore be determined not with reference to only the particular descriptions above, but also with reference to the appended claims, along with their full range of equivalence.

1. A battery, formed of an electrochemical energy cell, comprising:
at least one galvanic cell including:
an anode electrode unit;
a cathode electrode unit;
an electrolyte body between the anode and cathode electrode units and contacting both the anode and cathode electrode units; and
a separator layer including the electrolyte body and placed within the cell to contact both the anode and cathode electrode units to bring the anode and cathode electrode units in contact with the electrolyte body,
wherein the electrochemical energy cell is configured to operate as a battery through electrochemical energy generation and galvanic action,
wherein the cathode electrode unit includes a cathode material comprising a powder mixture of a powder of hydrated ruthenium oxide and one or more additives,
wherein the anode electrode unit includes a structure formed of an oxidizable metal,
wherein the separator layer comprises a material that is porous to ions in liquid and is electrically non-conductive, and
wherein the electrolyte body comprises a liquid solution or a gel that is configured to permit a movement of ions between the anode electrode unit and the cathode electrode unit, accept the ions for the battery from the anode electrode unit, and supply the ions to the cathode electrode unit.

2. The battery of claim 1, wherein a size of a surface area of the cell is larger than a size of a footprint of the cell, and wherein the anode electrode unit is configured to increase a conductivity level of the cell and increase a surface area of the electrolyte body.

3. The battery of claim 1, wherein the additives comprises activated carbon and at least one other additive.

4. (canceled)

5. The battery of claim 1, further comprising a cathode current collector structure, wherein the cathode material is suspended in the electrolyte body and spread over the cathode current collector structure.

6. The battery of claim 1, wherein the cathode electrode unit comprises a coating of the cathode material on an electrically conductive, chemically inert material that serves as a cathode current collector.

7.-11. (canceled)

12. The battery of claim 1, wherein the cathode material has an effective surface area over which reactions that constitute the battery operation occur, wherein the effective surface area of the cathode material affects a level of a performance of the battery, wherein the effective surface area is larger than a footprint area of the cell, wherein the effective surface area is achieved by the use of ruthenium oxide particles compounded with activated carbon particles distributed over a surface of a cathode current collector by means of coating or other techniques, such that a surface area presented to the electrolyte body by the ruthenium oxide particles distributed between and over activated carbon particles is larger than the footprint area of the cell.

13. The battery of claim 1, wherein the battery comprises a folded design structure or has the cathode electrode unit or the anode electrode unit substantially positioned within a pocket structure of the battery.

14. The battery of claim 1, wherein the cathode material has a surface area that affects a level of a performance of the battery, and wherein a size of the surface area is determined as a function of at least one of the following: material properties of the cathode material, a porosity of hydrated ruthenium oxide particles, a porosity of activated carbon particles, sizes of the hydrated ruthenium oxide and activated carbon particles, or a mixing method involving placing the cell in a sonic bath, and wherein the surface area is greater than a footprint area of the battery.

15.-16. (canceled)

17. The battery of claim 15, wherein the cathode electrode unit further comprises additives suspended in an electrolyte spread on the cathode current collector.

18.-20. (canceled)

21. The battery of claim 1, wherein the additives comprises one or more of agar, sucrose, sorbitol, platinum, palladium, iridium oxide, indium oxide, magnetite, Nafion™, metal-functionalized carbon nanotubes, nickel-plated carbon nanotubes, titanium dioxide, tungsten carbide, sodium chloride, and polyethylene glycols.

22. (canceled)

23. The battery of claim 1, wherein the structure for the anode electrode unit is formed in a form of a layer, a sheet, a foil or a mesh, wherein the oxidizable metal comprises at least one of zinc, aluminum, tin or lead.

24.-27. (canceled)

28. The battery of claim 1, wherein the electrolyte body is configured to increase a level of a capacity of the cell by having a property that affects a rate of electron acceptance from an external circuit by having the cathode material of at least the powder of hydrated ruthenium oxide in the cell.

29.-31. (canceled)

32. The battery of claim 1, wherein the electrolyte body comprises a gel form, wherein the gel form comprises gelling agents.

33. The battery of claim 32, wherein the gelling agents comprises at least one of agar or carboxymethyl cellulose.

34. A device comprising an electrochemical cell and configured to operate as a battery, the electrochemical cell comprising:
an anode electrode unit;
a cathode electrode unit; and
a first electrolyte body sandwiched between the anode and the electrode units,
wherein the cathode electrode unit includes a cathode material having at least a powder mixture of a powder of ruthenium oxide with activated carbon (AC) particles suspended in a second electrolyte body,
wherein the electrochemical cell is bendable and twistable to form a non-planar shape,
wherein the electrochemical cell is configured for a reduction-oxidation (redox) reaction to generate power at a surface of one or both of the electrode units, and
wherein the first electrolyte body comprises a liquid solution or a gel that is configured to permit a movement of ions between the anode electrode unit and the cathode electrode unit, accept the ions for the battery from the anode electrode unit, and supply the ions to the cathode electrode unit.

35. A method of fabricating a flexible electrochemical cell configured to operate as a battery, the method comprising:
forming a backing layer of predetermined dimensions;
identifying a predetermined active area on a surface of the backing layer;
mixing a powder mixture from a powder of hydrated ruthenium oxide and a powder of activated carbon;
preparing a paste from the powder mixture and an electrolyte;
depositing the paste on the active area on the backing layer;
applying the paste into the backing layer, thereby forming a cathode electrode unit, wherein the backing layer serves as a current collector;
forming a metal anode electrode unit;
forming a separator layer of predetermined dimensions from a permeable electrically insulating material;
positioning the separator layer on the cathode electrode unit contiguous to the paste dispersed on the active area;
impregnating the separator layer with the electrolyte; and
attaching the metal anode electrode unit to the cathode electrode unit with the separator layer sandwiched therebetween,
wherein the electrolyte comprises a liquid solution or a gel that is configured to permit a movement of ions between the anode electrode unit and the cathode electrode unit, accept the ions for the battery from the anode electrode unit, and supply the ions to the cathode electrode unit.

36. The method of claim 35, wherein the forming of the backing layer comprises forming the backing layer of predetermined dimensions from a flexible metal, mylar, plastic mesh or foil coated with an electrically conductive, chemically isolating polymer comprising polyaniline or polypyrrole.

37. The method of claim 36, wherein applying the paste comprises applying the paste into the active area on the backing foil, thereby forming the cathode electrode unit.

38. The method of claim 35, wherein the forming the backing layer comprises forming the backing layer of predetermined dimensions from a flexible graphite mesh or carbon cloth.

39. The method of claim 38, wherein the metal anode electrode unit is formed from a flexible sheet or foil of an oxidizable metal or the metal anode electrode unit is formed from a flexible mesh of an oxidizable metal.

40.-46. (canceled)
